(19) United States
(12) Patent Application Publication
(10) Pub. No.: US 2025/0367921 A1
(43) Pub. Date: Dec. 4, 2025

(54) LIQUID EJECTING APPARATUS AND METHOD OF CONTROLLING LIQUID EJECTING APPARATUS

(71) Applicant: SEIKO EPSON CORPORATION, Tokyo (JP)

(72) Inventor: Akira MIYAGISHI, SHIOJIRI-SHI (JP)

(21) Appl. No.: 19/223,601

(22) Filed: May 30, 2025

(30) Foreign Application Priority Data
May 31, 2024 (JP) 2024-088755

(51) Int. Cl. B41J 2/045

(52) U.S. Cl. CPC B41J 2/04525; B41J 2/0455; B41J 2/04573; B41J 2/04581; B41J 2/04588

(57) ABSTRACT

The waveform determining section causes the detection circuit to detect, as a first residual vibration, a residual vibration of the vibration plate after N piezoelectric elements corresponding to N nozzles among the plurality of nozzles are driven with an evaluation waveform in which a rate of change in an electrical potential is a first electrical potential change rate, and causes the detection circuit to detect, as a second residual vibration, a residual vibration of the vibration plate after the N piezoelectric elements are driven with an evaluation waveform in which the rate of change in the electrical potential is a second electrical potential change rate lower than the first electrical potential change rate, and determines a waveform of a drive signal based on the first residual vibration and the second residual vibration.

The present application is based on, and claims priority from JP Application Serial Number 20024-088755, filed May 31, 2024, the disclosure of which is hereby incorporated by reference herein in its entirety.

### BACKGROUND

### 1. Technical Field

The present disclosure relates to a liquid ejecting apparatus and a method of controlling a liquid ejecting apparatus.

### 2. Related Art

A liquid ejecting apparatus that prints an image by ejecting liquid such as ink from a nozzle using a piezoelectric element is known. For example, the liquid ejecting apparatus includes a liquid ejecting head that ejects the liquid filling a pressure chamber from the nozzle by causing the piezoelectric element to vibrate a vibration plate that constitutes a portion of the pressure chamber. In this type of liquid ejecting apparatus, to simultaneously eject ink from a plurality of nozzles, a plurality of piezoelectric elements are simultaneously driven. When a plurality of piezoelectric elements are simultaneously driven, so-called electrical crosstalk may occur in which a waveform of a drive signal is disturbed due to an effect of a resistance component, a capacitance component, and an inductance component of signal wiring or the like from a circuit which generates the drive signal for the piezoelectric elements to each of the piezoelectric elements. Therefore, various techniques for suppressing the occurrence of electrical crosstalk have been proposed. For example, JP-A-2016-159573 discloses a liquid ejecting apparatus in which the timing of driving piezoelectric elements is shifted between adjacent nozzles or between adjacent nozzle rows in order to suppress electrical crosstalk.

The electrical crosstalk greatly depends not only on the number of piezoelectric elements driven at the same time, but also on a drive waveform which is a waveform of a drive signal, for example, a rate of change in an electrical potential of a specific waveform element such as a waveform element in which an electrical potential largely changes. For example, a business model in which a head manufacturer that manufactures a liquid ejecting head assembles a liquid ejecting apparatus is considered. In this type of business model, for example, by adjusting a rate of change in an electrical potential of a specific waveform element in advance, the head manufacturer can determine in advance an appropriate drive waveform that suppresses the occurrence of electrical crosstalk under usage conditions of the liquid ejecting apparatus. In addition, in contrast to the business model in which the head manufacturer assembles the liquid ejecting apparatus, a head external sales business model is considered in which a head manufacturer sells a liquid ejecting head to a printing apparatus manufacturer and the printing apparatus manufacturer assembles a liquid ejecting apparatus. In the head external sales business model, since usage conditions of the liquid ejecting apparatus vary depending on the specifications of the printing apparatus manufacturer, it is difficult for the head manufacturer to adjust a rate of change in an electrical potential of a specific waveform element in advance. Therefore, it is desired to appropriately and easily determine a drive waveform that suppresses the occurrence of electrical crosstalk under the usage conditions of the liquid ejecting apparatus in the head external sales business model. The problems described above are desired to be relatively minor even when the manufacturer that manufactures the liquid ejecting apparatus and the manufacturer that manufactures the liquid ejecting head have the same business model. For example, it is also considered that a user uniquely sets usage conditions different from usage conditions assumed in advance by the manufacturer of the liquid ejecting head or the manufacturer of the liquid ejecting apparatus, and in this case, similar problems occur.

### SUMMARY

In order to solve the above-described problems, according to an aspect of the present disclosure, a liquid ejecting apparatus includes: a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the plurality of piezoelectric elements is driven; and a controller. The controller causes the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate, causes the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate, and determines a waveform of the drive signal based on the first residual vibration and the second residual vibration.

In addition, according to another aspect of the present disclosure, a method of controlling a liquid ejecting apparatus including a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the piezoelectric elements is driven includes: causing the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate; causing the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate; and determining a waveform of the drive signal based on the first residual vibration and the second residual vibration.

### BRIEF DESCRIPTION OF THE DRAWINGS

FIG. 1 is a block diagram illustrating an example of a configuration of a liquid ejecting apparatus according to an embodiment of the present disclosure.

FIG. 2 is a configuration diagram schematically illustrating the liquid ejecting apparatus.

FIG. 3 is an exploded perspective view of a liquid ejecting head.

FIG. 4 is a sectional view taken along line IV-IV illustrated in FIG. 3.

FIG. 5 is a block diagram illustrating an example of a configuration of the liquid ejecting head.

FIG. 6 is a timing chart illustrating an example of an operation of the liquid ejecting apparatus in a unit period of time.

FIG. 7 is a diagram illustrating an example of an evaluation waveform and a waveform of a residual vibration.

FIG. 8 is a flowchart illustrating an example of an operation of the liquid ejecting apparatus for determination of a waveform of a drive signal.

FIG. 9 is a flowchart illustrating an example of a waveform determination process illustrated in FIG. 8.

FIG. 10 is a flowchart illustrating an example of an operation of a liquid ejecting apparatus according to a first modification example.

FIG. 11 is a flowchart illustrating an example of a waveform determination process illustrated in FIG. 10.

### DESCRIPTION OF EMBODIMENTS

Hereinafter, an embodiment of the present disclosure will be described with reference to the drawings. Meanwhile, in each drawing, the dimensions and scale of each section are different from the actual dimensions and scale as appropriate. In addition, the embodiment described below is a preferred specific example of the present disclosure and various technically preferred limitations are added, but the scope of the present disclosure is not limited to the embodiment unless description for limiting the present disclosure is particularly made in the following description.

### 1. EMBODIMENT

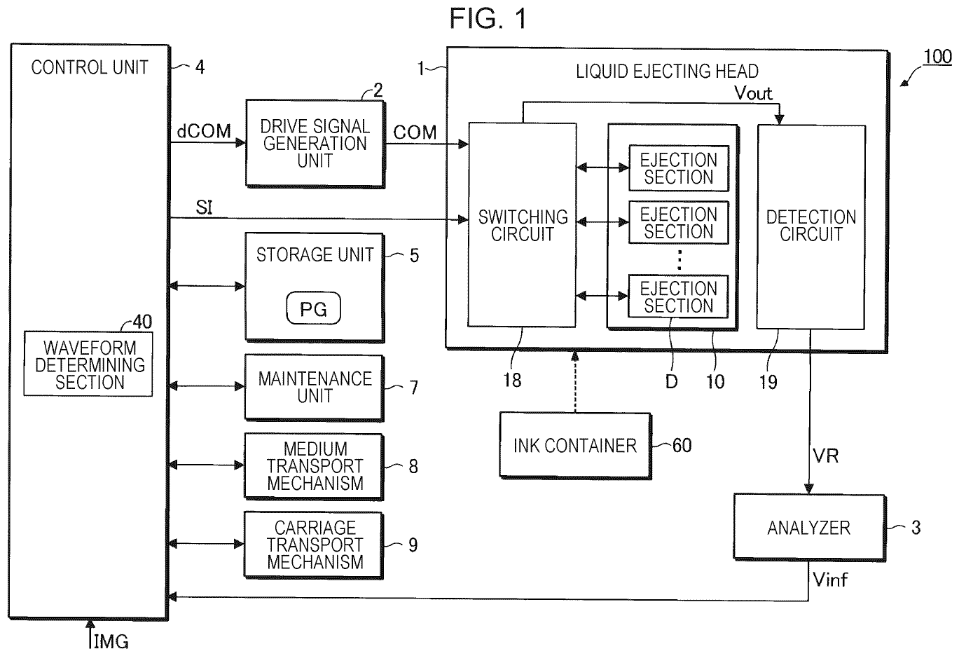

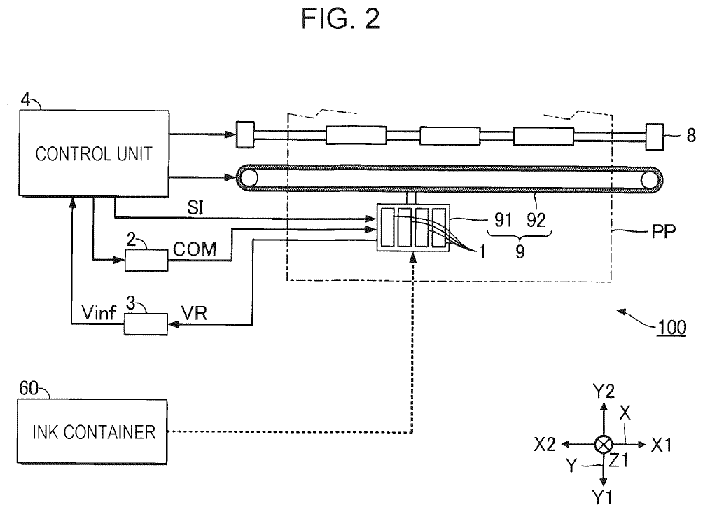

First, an outline of a liquid ejecting apparatus 100 according to the present embodiment will be described with reference to FIG. 1. In the present embodiment, a case where the liquid ejecting apparatus 100 is an ink jet printer that ejects ink to a medium PP to form an image is assumed as an example. In the present embodiment, recording paper illustrated in FIG. 2 to be described later is assumed as the medium PP. The ink is an example of “liquid”.

FIG. 1 is a block diagram illustrating an example of a configuration of the liquid ejecting apparatus 100 according to the embodiment of the present disclosure.

For example, print data IMG indicating an image to be formed by the liquid ejecting apparatus 100 is supplied to the liquid ejecting apparatus 100 from a host computer such as a personal computer or a digital camera. The liquid ejecting apparatus 100 performs a printing process of forming, on the medium PP, the image indicated by the print data IMG supplied from the host computer.

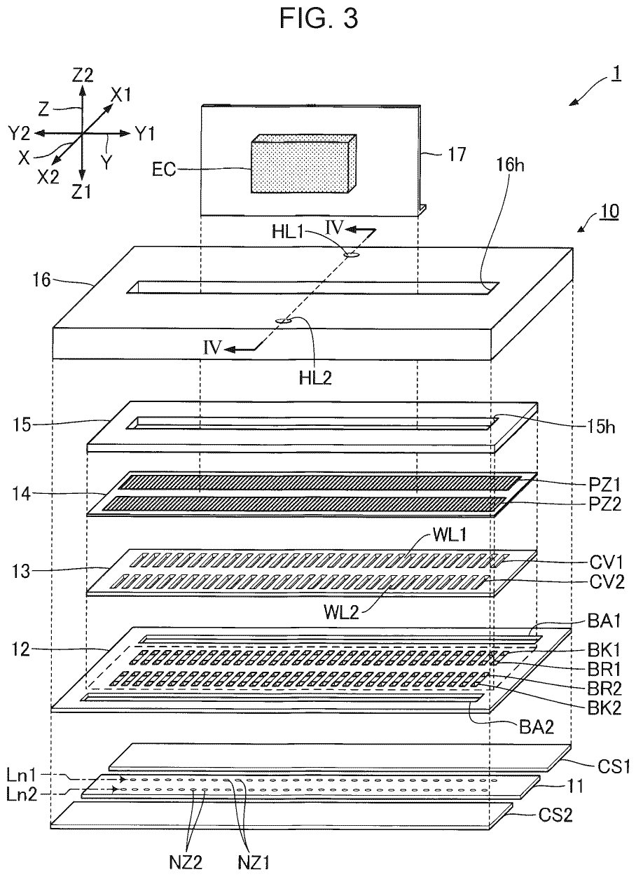

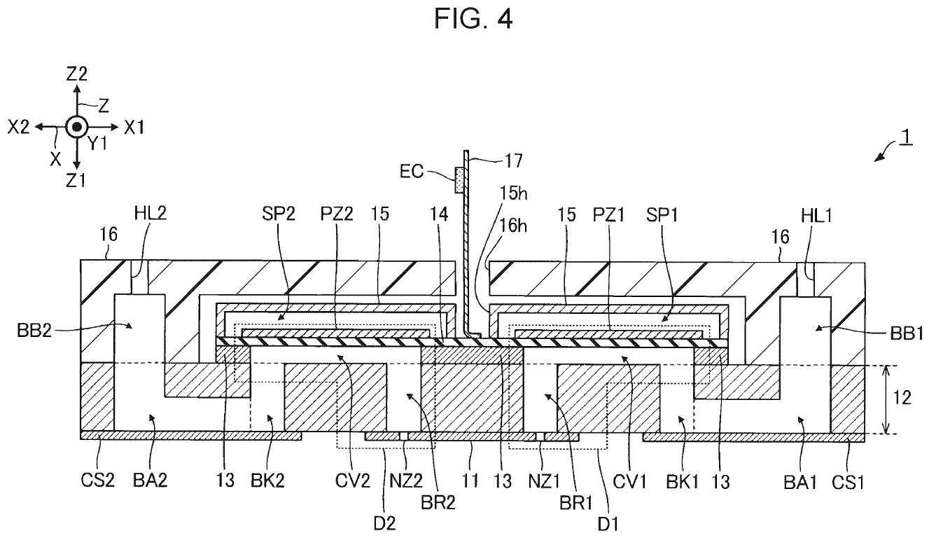

The liquid ejecting apparatus 100 includes a liquid ejecting head 1 including ejection sections D, a drive signal generation unit 2 that generates a drive signal COM for driving the ejection sections D, and an analyzer 3 that analyzes a residual vibration (described later). Each of the ejection sections D includes a nozzle NZ from which ink is ejected. The nozzles NZ will be described later with reference to FIGS. 3 and 4. In addition, the liquid ejecting apparatus 100 includes a control unit 4 that controls each section of the liquid ejecting apparatus 100, and a storage unit 5 that stores various types of information such as the print data IMG and a control program PG for the liquid ejecting apparatus 100. Further, the liquid ejecting apparatus 100 includes a maintenance unit 7 that performs a maintenance process on the liquid ejecting head 1, a medium transport mechanism 8 that transports the medium PP, a carriage transport mechanism 9 that causes a carriage 91 to reciprocate, and an ink container 60 that stores the ink. The carriage 91 will be described later with reference to FIG. 2.

In the present embodiment, a case where the liquid ejecting head 1 corresponds to the drive signal generation unit 2 and the liquid ejecting head 1 corresponds to the analyzer 3 is assumed. For example, the liquid ejecting apparatus 100 may include a plurality of liquid ejecting heads 1, a plurality of drive signal generation units 2, and a plurality of analyzers 3. In this case, for example, the plurality of drive signal generation units 2 correspond to the plurality of liquid ejecting heads 1 on a one-to-one basis, and the plurality of analyzers 3 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, and one analyzer 3 corresponding to the liquid ejecting head 1.

In the present embodiment, a case where the liquid ejecting apparatus 100 includes four liquid ejecting heads 1 corresponding to four types of ink of cyan, magenta, yellow, and black, respectively is assumed. That is, in the present embodiment, a case where the liquid ejecting apparatus 100 includes the four liquid ejecting heads 1, four drive signal generation units 2, and four analyzers 3 is assumed. However, hereinafter, for convenience of description, as illustrated in FIG. 1, the following description may focus on one liquid ejecting head 1 among the four liquid ejecting heads 1, one drive signal generation unit 2 corresponding to the one liquid ejecting head 1, and one analyzer 3 corresponding to the one liquid ejecting head 1.

First, the control unit 4, the drive signal generation unit 2, and the storage unit 5 will be described before the liquid ejecting head 1 is described.

The control unit 4 includes one or a plurality of central processing units (CPU). The control unit 4 may include a programmable logic device such as a field-programmable gate array (FPGA), instead of the one or plurality of CPUs or in addition to the one or plurality of CPUs. In addition, for example, the control unit 4 generates signals for controlling an operation of each section of the liquid ejecting apparatus 100, such as a print signal SI and a waveform specifying signal dCOM, by operating in accordance with the control program PG stored in the storage unit 5.

The waveform specifying signal dCOM is a digital signal that defines a waveform of the drive signal COM. In addition, the drive signal COM is an analog signal for driving the ejection sections D. In the present embodiment, a case where one drive signal COM is output from the drive signal generation unit 2 to the liquid ejecting head 1 is assumed, but a plurality of drive signals COM may be output from the drive signal generation unit 2 to the liquid ejecting head 1. In addition, the print signal SI is a digital signal for specifying a type of operation of the ejection sections D. Specifically, the print signal SI is a signal for specifying a type of operation of the ejection sections D by specifying whether or not the drive signal COM is supplied to the ejection sections D.

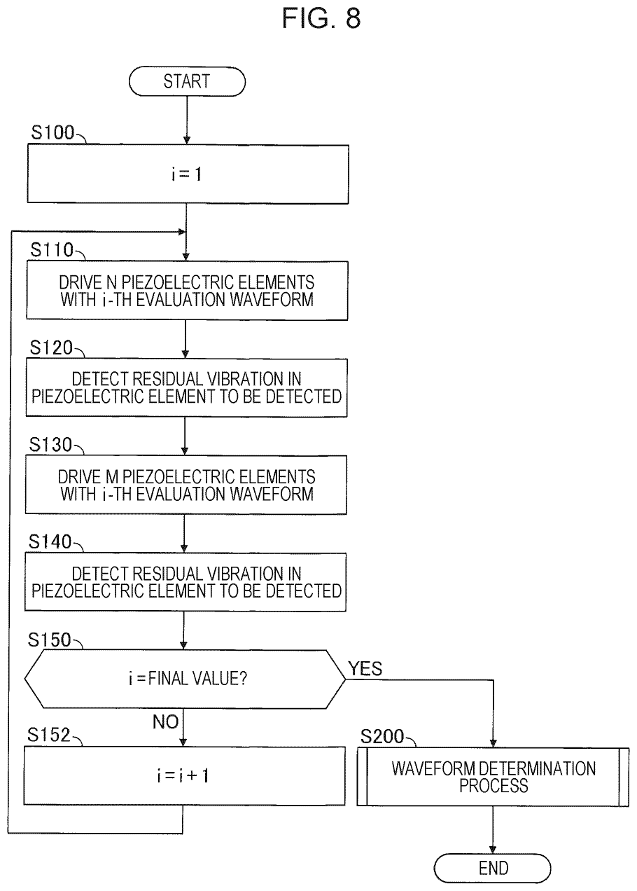

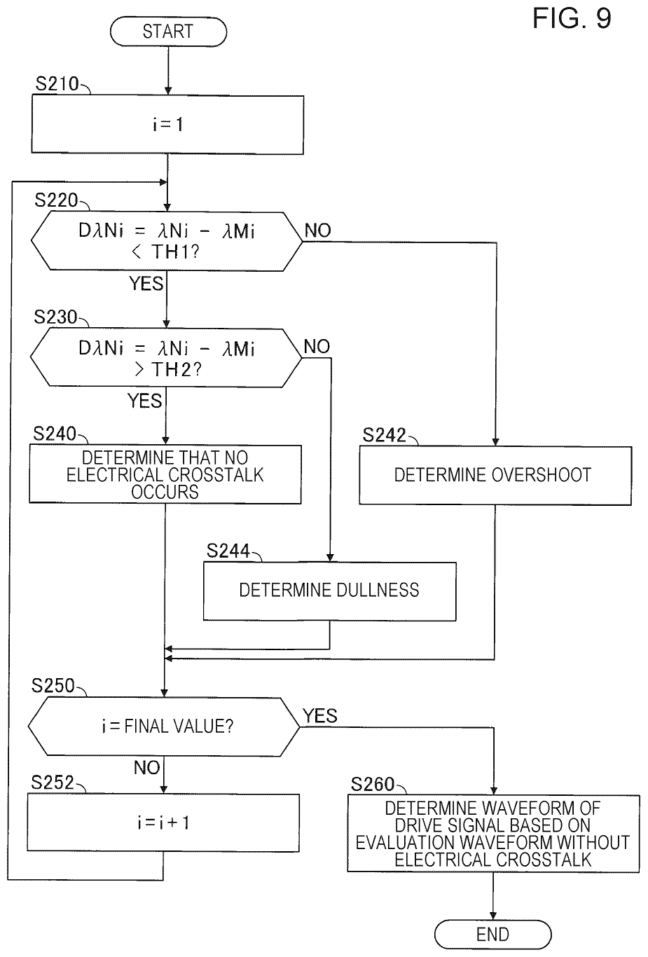

In the present embodiment, the control unit 4 operates in accordance with the control program PG stored in the storage unit 5 to function as a waveform determining section 40. The control program PG may be provided from, for example, a head manufacturer that manufactures the liquid ejecting head 1. Details of an operation of the waveform determining section 40 will be described with reference to FIGS. 8 and 9, but for example, the waveform determining section 40 evaluates electrical crosstalk between the plurality of nozzles NZ based on a residual vibration analyzed by the analyzer 3. Then, for example, the waveform determining section 40 determines the waveform of the drive signal COM defined by the waveform specifying signal dCOM based on a result of evaluating the electrical crosstalk. The electrical crosstalk is, for example, an effect in which noise is superimposed on the drive signal COM due to the plurality of ejection sections D being simultaneously driven. Specifically, the electrical crosstalk is an effect in which the waveform of the drive signal COM is disturbed due to an effect of a resistance component, a capacitance component, and an inductance component of signal wiring or the like from the drive signal generation unit 2 to each of the ejection sections D when the plurality of ejection sections D are simultaneously driven.

Note that, as crosstalk, in addition to electrical crosstalk, so-called structural crosstalk that occurs due to the structure of the liquid ejecting head 1, such as the arrangement of the ejection sections D, is known. In the present embodiment, attention is paid to electrical crosstalk. For example, in the present embodiment, as described above, the electrical crosstalk is evaluated by the waveform determining section 40. The waveform determining section 40 is an example of a “controller”.

The drive signal generation unit 2 includes, for example, a digital analog converter (DAC), and generates the drive signal COM based on the waveform specifying signal dCOM supplied from the control unit 4. For example, the drive signal COM generated by the drive signal generation unit 2 includes the waveform defined by the waveform specifying signal dCOM. The drive signal generation unit 2 outputs the drive signal COM generated based on the waveform specifying signal dCOM to a switching circuit 18 included in the liquid ejecting head 1.

The storage unit 5 includes one or both of a volatile memory, such as a random-access memory (RAM), and a nonvolatile memory, such as a read-only memory (ROM), an electrically erasable programmable read-only memory (EEPROM), or a programmable ROM (PROM). The storage unit 5 may be included in the control unit 4.

The liquid ejecting head 1 includes the switching circuit 18, a recording head 10, and a detection circuit 19. The detection circuit 19 is an example of a “detecting section”.

The recording head 10 includes the K ejection sections D. In the present embodiment, it is assumed that the value K is an even number greater than or equal to 2. Hereinafter, the k-th ejection section D among the K ejection sections D provided in the recording head 10 may be referred to as an ejection section D[k]. The variable k is a natural number satisfying “1≤k≤K”. In addition, hereinafter, when a constituent element, a signal, or the like of the liquid ejecting apparatus 100 corresponds to the ejection section D[k] among the K ejection sections D, a suffix [k] may be added to a reference sign for representing the constituent element, the signal, or the like.

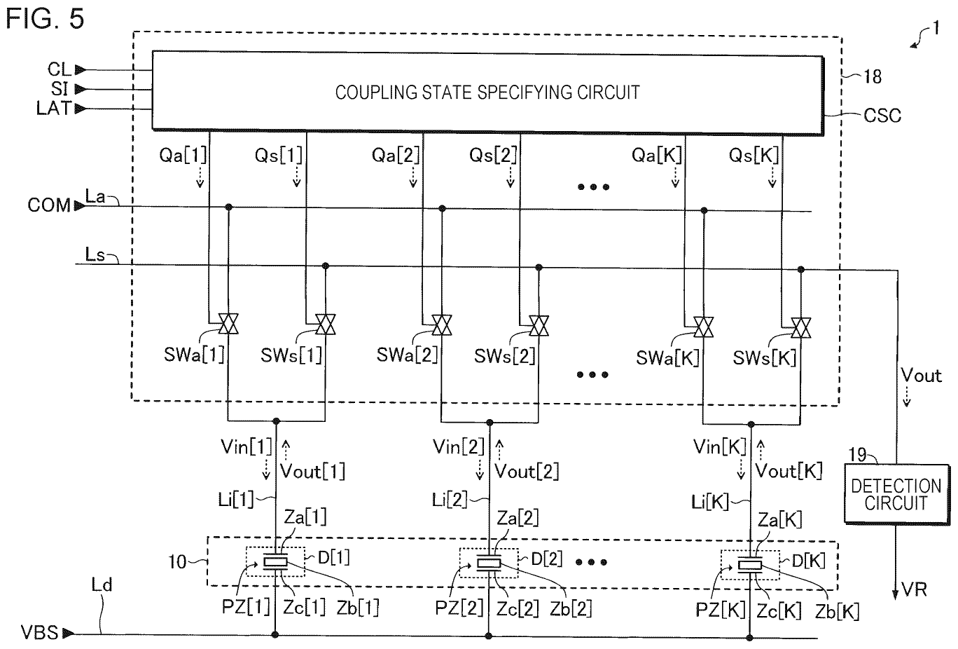

The switching circuit 18 switches whether or not to supply a drive signal COM to the ejection section D[k] based on the print signal SI. Hereinafter, as illustrated in FIG. 5 and the like which will be described later, among drive signals COM, a drive signal COM supplied to the ejection section D[k] may be referred to as an individual drive signal Vin[k]. In addition, the switching circuit 18 switches whether or not to electrically couple the ejection section D[k] and the detection circuit 19 based on the print signal SI. When the ejection section D[k] and the detection circuit 19 are electrically coupled, for example, a detection signal Vout[k] detected from the ejection section D[k] is supplied to the detection circuit 19 through the switching circuit 18. The detection signal Vout[k] is, for example, an analog signal indicating a waveform of a residual vibration which remains in the ejection section D[k] after the ejection section D[k] is driven by the individual drive signal Vin[k]. Specifically, for example, the detection signal Vout[k] indicates a waveform of a residual vibration of a vibration plate 14 after a piezoelectric element PZ[k] is driven. Piezoelectric elements PZ and the vibration plate 14 will be described later with reference to FIGS. 3 and 4.

The detection circuit 19 generates a residual vibration signal VR[k] based on the detection signal Vout[k]. For example, the detection circuit 19 shapes the detection signal Vout[k] into a waveform suitable for processing in the analyzer 3 by amplifying the amplitude of the detection signal Vout[k] or removing a noise component included in the detection signal Vout[k]. By the shaping, the residual vibration signal VR[k] is generated. For example, the detection circuit 19 may include a negative feedback amplifier that amplifies the detection signal Vout[k], a low-pass filter that attenuates a high-frequency component of the detection signal Vout[k], and a voltage follower that converts impedance and outputs the residual vibration signal VR[k] of low impedance.

For example, the residual vibration signal VR[k] generated based on the detection signal Vout[k] is an analog signal indicating the waveform of the residual vibration of the vibration plate 14 after the piezoelectric element PZ[k] is driven by the individual drive signal Vin[k]. The detection circuit 19 outputs the residual vibration signal VR[k] generated based on the detection signal Vout[k] to the analyzer 3. In this manner, the detection circuit 19 detects, based on the detection signal Vout[k], the residual vibration of the vibration plate 14 caused by the driving of the piezoelectric element PZ[k].

The analyzer 3 includes, for example, an analog-to-digital converter (ADC), and converts the analog residual vibration signal VR[k] into a digital signal. Then, for example, the analyzer 3 analyzes the residual vibration detected by the detection circuit 19 using the residual vibration signal VR[k] converted into the digital signal. In addition, the analyzer 3 generates residual vibration information Vinf indicating a result of analyzing the residual vibration and outputs the generated residual vibration information Vinf to the control unit 4. The residual vibration information Vinf indicates, for example, the amplitude of the residual vibration. However, when the residual vibration information Vinf includes information indicating the amplitude of the residual vibration, the residual vibration information Vinf may include information other than the amplitude of the residual vibration. The information other than the amplitude of the residual vibration may be, for example, information including one or both of the period and the phase of the residual vibration, or information including information other than the period and the phase of the residual vibration. The waveform determining section 40 described above evaluates electrical crosstalk between the plurality of nozzles NZ based on, for example, the residual vibration information Vinf. The analyzer 3 may be included in the control unit 4. For example, the control unit 4 may function as the analyzer 3 by operating in accordance with the control program PG stored in the storage unit 5. In addition, a portion of the analyzer 3 may be included in the control unit 4. Specifically, the ADC may be provided outside the control unit 4, and the control unit 4 may have a function of analyzing a residual vibration by using a residual vibration signal VR converted into a digital signal.

In addition, in the present embodiment, as described above, the maintenance process is performed by the maintenance unit 7. For example, the maintenance unit 7 performs the maintenance process under control by the control unit 4. The maintenance process includes, for example, a flushing process in which ink is ejected from the ejection sections D, a wiping process in which foreign matter such as ink adhering to the vicinity of the nozzles NZ of the ejection sections D is wiped off by a wiper, and a pumping process in which ink inside the ejection sections D is suctioned by a tube pump or the like.

The maintenance unit 7 includes an ejected ink receiving section that receives ejected ink when the ink in the ejection sections D is ejected in the flushing process, the wiper that wipes off foreign matter such as ink adhering to the vicinity of the nozzles NZ of the ejection sections D, and the tube pump that suctions ink, air bubbles, and the like in the ejection sections D. The ejected ink receiving section, the wiper, and the tube pump are not illustrated.

Next, a schematic overall configuration of the liquid ejecting apparatus 100 will be described with reference to FIG. 2.

FIG. 2 is a configuration diagram schematically illustrating the liquid ejecting apparatus 100. The ink container 60, the medium transport mechanism 8, and the carriage transport mechanism 9 will be mainly described with reference to FIG. 2.

The ink container 60 stores the ink. As the ink container 60, for example, a cartridge that can be attached to and detached from the liquid ejecting apparatus 100, a bag-shaped ink pack formed of a flexible film, an ink tank that can be replenished with ink, or the like can be used. The types of ink stored in the ink container 60 are not particularly limited, and any type of ink may be stored in the ink container 60. In the present embodiment, as described above, a case where the liquid ejecting apparatus 100 includes the four liquid ejecting heads 1 corresponding to the four types of ink of cyan, magenta, yellow, and black is assumed. Therefore, in the present embodiment, the ink container 60 stores the four types of ink of cyan, magenta, yellow, and black. In addition, the ink container 60 supplies the stored ink to the liquid ejecting heads 1.

The medium transport mechanism 8 transports the medium PP in a Y1 direction along a Y axis under control by the control unit 4. Hereinafter, the Y1 direction and a Y2 direction opposite to the Y1 direction will be collectively referred to as a Y-axis direction. In addition, hereinafter, an X1 direction along an X axis that intersects the Y axis and an X2 direction opposite to the X1 direction will be collectively referred to as an X-axis direction. In addition, hereinafter, a Z1 direction along a Z axis that intersects the X axis and the Y axis and a Z2 direction opposite to the Z1 direction will be collectively referred to as a Z-axis direction. In the present embodiment, for example, description will be made on the assumption that the X axis, the Y axis, and the Z axis are orthogonal to each other. However, the present disclosure is not limited to such an aspect. The X axis, the Y axis, and the Z axis may intersect one another.

The carriage transport mechanism 9 causes the plurality of liquid ejecting heads 1 to reciprocate in the X1 direction and the X2 direction under control by the control unit 4. As illustrated in FIG. 2, the carriage transport mechanism 9 includes the substantially box-shaped carriage 91 storing the plurality of liquid ejecting heads 1, and an endless belt 92 to which the carriage 91 is fixed. The ink container 60 may be stored in the carriage 91 together with the liquid ejecting heads 1.

The liquid ejecting head 1 is driven by the drive signal COM under control by the print signal SI, and ejects the ink in the Z1 direction from some or all of the plurality of nozzles NZ provided in the liquid ejecting head 1. That is, the liquid ejecting head 1 forms a desired image on a front surface of the medium PP by ejecting the ink from some or all of the plurality of nozzles NZ in coordination with the transport of the medium PP by the medium transport mechanism 8 and the reciprocation of the liquid ejecting head 1 by the carriage transport mechanism 9 and causing the ejected ink to land on the front surface of the medium PP. In the present embodiment, as described above, the Z1 direction is an ejection direction in which the ink is ejected from the nozzles NZ.

Next, a schematic structure of the liquid ejecting head 1 will be described with reference to FIGS. 3 and 4.

FIG. 3 is an exploded perspective view of the liquid ejecting head 1. FIG. 4 is a sectional view taken along line IV-IV illustrated in FIG. 3. The cross section taken along line IV-IV is parallel to an XZ plane and passes through inlets HL1 and HL2 to be described later. In FIGS. 3 and 4, in order to distinguish two nozzle rows Ln to be described later from one another, a number “1” or “2” is added to the end of the reference sign of each of the nozzle rows Ln. In addition, in FIGS. 3 and 4, for easy understanding of the description, the number “1” is added to the end of the reference sign of each of the nozzles NZ included in the nozzle row Ln1, and the number “2” is added to the end of the reference sign of each of the nozzles NZ included in the nozzle row Ln2.

As illustrated in FIGS. 3 and 4, the liquid ejecting head 1 includes a nozzle substrate 11, compliance sheets CS1 and CS2, a communication plate 12, a pressure chamber substrate 13, the vibration plate 14, a sealing substrate 15, a flow path forming substrate 16, and a wiring substrate 17 on which an electronic component EC is mounted. The electronic component EC includes, for example, electric circuits such as the switching circuit 18 and the detection circuit 19. For example, the recording head 10 is electrically coupled to the switching circuit 18, the detection circuit 19, and the like via the wiring substrate 17.

As illustrated in FIG. 3, the recording head 10 includes, for example, the nozzle substrate 11, the compliance sheets CS1 and CS2, the communication plate 12, the pressure chamber substrate 13, the vibration plate 14, the sealing substrate 15, and the flow path forming substrate 16.

The nozzle substrate 11 is a plate-shaped member elongated in the Y-axis direction and extending substantially parallel to an XY plane. Herein, “substantially parallel” is a concept that includes not only a state of being completely parallel but also a state of being considered to be parallel in consideration of an error. In the present embodiment, “substantially parallel” is a concept that includes a state of being considered to be parallel in consideration of an error of approximately 10%. “Substantially orthogonal” to be described later is also a concept that includes a state of being considered to be orthogonal in consideration of an error, in addition to a state of being completely orthogonal, as in the state of “substantially parallel”. The nozzle substrate 11 is manufactured, for example, by processing a silicon single crystal substrate using a semiconductor manufacturing technique, such as etching, but any known material and manufacturing method may be adopted to manufacture the nozzle substrate 11.

In the nozzle substrate 11, the K nozzles NZ are formed. Each of the nozzles NZ is a through hole provided in the nozzle substrate 11. In the present embodiment, it is assumed that the plurality of nozzles NZ formed in the nozzle substrate 11 include a plurality of nozzles NZ1 arranged in the Y-axis direction, and a plurality of nozzles NZ2 arranged in the Y-axis direction at positions in the X2 direction as viewed from the plurality of nozzles NZ1. Hereinafter, the plurality of nozzles NZ1 arranged in the Y-axis direction are also referred to as the nozzle row Ln1, and the plurality of nozzles NZ2 arranged in the Y-axis direction are also referred to as the nozzle row Ln2. For example, the number of nozzles NZ included in each of the nozzle rows Ln1 and Ln2 is half the value K. Hereinafter, the nozzle row Ln1 and the nozzle row Ln2 may be collectively referred to as the nozzle rows Ln. In addition, in FIGS. 3 and 4, in order to facilitate understanding of the description, the number “1” is added to the ends of reference signs of components corresponding to the nozzle row Ln1 and the number “2” is added to the ends of reference signs of components corresponding to the nozzle row Ln2 in the liquid ejecting head 1.

As illustrated in FIGS. 3 and 4, the communication plate 12 is provided at a position in the Z2 direction as viewed from the nozzle substrate 11. The communication plate 12 is a plate-shaped member elongated in the Y-axis direction and extending substantially parallel to the XY plane. The communication plate 12 is manufactured, for example, by processing a silicon single crystal substrate using a semiconductor manufacturing technique, but any known material and manufacturing method may be adopted to manufacture the communication plate 12.

A flow path for ink is formed in the communication plate 12. Specifically, in the communication plate 12, one supply flow path BA1 extending in the Y-axis direction and one supply flow path BA2 extending in the Y-axis direction at a position in the X2 direction as viewed from the supply flow path BA1 are formed. In addition, in the communication plate 12, a plurality of coupling flow paths BK1 corresponding to the plurality of nozzles NZ1, a plurality of coupling flow paths BK2 corresponding to the plurality of nozzles NZ2, a plurality of communication flow paths BR1 corresponding to the plurality of nozzles NZ1, and a plurality of communication flow paths BR2 corresponding to the plurality of nozzles NZ2 are formed.

As illustrated in FIG. 4, the coupling flow paths BK1 communicate with the supply flow path BA1 and extend in the Z-axis direction at positions in the X2 direction as viewed from the supply flow path BA1. The communication flow paths BR1 extend in the Z-axis direction at positions in the X2 direction as viewed from the coupling flow paths BK1. Each of the communication flow paths BR1 communicates with the nozzle NZ1 corresponding to the communication flow path BR1. The coupling flow paths BK2 communicate with the supply flow path BA2 and extend in the Z-axis direction at positions in the X1 direction as viewed from the supply flow path BA2. The communication flow paths BR2 extend in the Z-axis direction at positions in the X1 direction as viewed from the coupling flow paths BK2 and in the X2 direction as viewed from the communication flow paths BR1. Each of the communication flow paths BR2 communicates with the nozzle NZ2 corresponding to the communication flow path BR2.

The supply flow paths BA1 and BA2 are also referred to as supply flow paths BA without being particularly distinguished, the coupling flow paths BK1 and BK2 are also referred to as coupling flow paths BK without being particularly distinguished, and the communication flow paths BR1 and BR2 are also referred to as communication flow paths BR without being particularly distinguished.

The pressure chamber substrate 13 is provided at a position in the Z2 direction as viewed from the communication plate 12, as illustrated in FIGS. 3 and 4. The pressure chamber substrate 13 is a plate-shaped member elongated in the Y-axis direction and extending substantially parallel to the XY plane. The pressure chamber substrate 13 is manufactured, for example, by processing a silicon single crystal substrate using a semiconductor manufacturing technique, but any known material and manufacturing method may be adopted to manufacture the pressure chamber substrate 13.

A flow path for ink is formed in the pressure chamber substrate 13. To be specific, in the pressure chamber substrate 13, a plurality of pressure chambers CV1 corresponding to the plurality of nozzles NZ1 and a plurality of pressure chambers CV2 corresponding to the plurality of nozzles NZ2 are formed. For example, as illustrated in FIG. 3, the plurality of pressure chambers CV1 are partitioned by a partition wall WL1 of the pressure chamber substrate 13 and are arranged in the Y-axis direction. Further, the plurality of pressure chambers CV2 are partitioned by a partition wall WL2 of the pressure chamber substrate 13 and are arranged in the Y-axis direction at positions in the X2 direction as viewed from the plurality of pressure chambers CV1. As illustrated in FIG. 4, the pressure chambers CV1 couple end portions of the coupling flow paths BK1 in the X2 direction and end portions of the communication flow paths BR1 in the X1 direction as viewed in the Z-axis direction, and extend in the X-axis direction. The pressure chambers CV2 couple end portions of the coupling flow paths BK2 in the X1 direction and end portions of the communication flow paths BR2 in the X2 direction as viewed in the Z-axis direction, and extend in the X-axis direction. The pressure chambers CV1 and CV2 are also referred to as pressure chambers CV without being particularly distinguished, and the partition walls WL1 and WL2 are also referred to as partition walls WL without being particularly distinguished.

The vibration plate 14 is provided at a position in the Z2 direction as viewed from the pressure chamber substrate 13, as illustrated in FIGS. 3 and 4. The vibration plate 14 is a plate-shaped member that is elongated in the Y-axis direction, extends substantially parallel to the XY plane, and is capable of vibrating elastically. In the present embodiment, the vibration plate 14 includes, for example, an elastic layer made of silicon oxide and an insulating layer made of zirconium oxide and provided at a position in the Z2 direction as viewed from the elastic layer. That is, in the present embodiment, a surface of the vibration plate 14 in the Z2 direction is formed of a non-conductive member. A surface of an element A in a first direction is a surface which is substantially orthogonal to the first direction among surfaces of the element A, and is a surface which is visible when the element A is viewed from the first direction to a second direction. The second direction is a direction opposite to the first direction. The elastic layer included in the vibration plate 14 is not limited to the elastic layer made of silicon oxide. Similarly, the insulating layer included in the vibration plate 14 is not limited to the insulating layer made of zirconium oxide.

As illustrated in FIGS. 3 and 4, a plurality of piezoelectric elements PZ1 corresponding to the plurality of pressure chambers CV1 and a plurality of piezoelectric elements PZ2 corresponding to the plurality of pressure chambers CV2 are provided at positions in the Z2 direction as viewed from the vibration plate 14. The piezoelectric elements PZ1 and PZ2 are also referred to as piezoelectric elements PZ without being particularly distinguished. The piezoelectric elements PZ are driven by the drive signal COM supplied to the piezoelectric elements PZ.

Although not illustrated in FIGS. 3 and 4, each of the piezoelectric elements PZ has a common electrode Zc to which a predetermined bias electrical potential VBS is supplied, an individual electrode Za to which an individual drive signal Vin is supplied, and a piezoelectric body Zb provided between the individual electrode Za and the common electrode Zc, as illustrated in FIG. 5. For example, the individual electrode Za, the piezoelectric body Zb, and the common electrode Zc are provided in this order along the Z2 direction on the surface of the vibration plate 14 in the Z2 direction. Herein, in the present specification, an expression “an element B is formed on a surface of an element A” is not intended to limit the configuration to a configuration where the element A and the element B are in direct contact with one another. That is, a configuration where an element C is formed on a front surface of the element A and the element B is formed on a front surface of the element C is also included in a concept that “the element B is formed on the surface of the element A” insofar as at least a portion of the element A and at least a portion of the element B overlap in plan view. In the present embodiment, the common electrode Zc is a so-called upper electrode, and the individual electrode Za is a so-called lower electrode. However, the common electrode Zc may be a lower electrode, and the individual electrode Za may be an upper electrode.

Each of the piezoelectric elements PZ is a passive element that is deformed according to a change in the electrical potential of the drive signal COM supplied to the individual electrode Za as an individual drive signal Vin. In other words, each of the piezoelectric elements PZ is an example of an energy conversion element that converts electrical energy of the drive signal COM into kinetic energy. Specifically, the piezoelectric elements PZ are driven and deformed according to a change in the electrical potential of the drive signal COM.

As illustrated in FIGS. 3 and 4, since the piezoelectric elements PZ are provided on the surface of the vibration plate 14 in the Z2 direction, the vibration plate 14 vibrates in coordination with the deformation of the piezoelectric elements PZ. That is, the vibration plate 14 vibrates by driving of the piezoelectric elements PZ. When the vibration plate 14 vibrates, pressure in the pressure chambers CV fluctuates. When the pressure in the pressure chambers CV fluctuates, the ink filling the pressure chambers CV is ejected from the nozzles NZ through the communication flow paths BR. As described above, the pressure chambers CV are filled with the ink, and pressure for ejecting the ink from the nozzles NZ is applied by the vibration of the vibration plate 14. In addition, a vibration remaining in the ejection section D[k] described with reference to FIG. 1 is also considered as, for example, a vibration remaining in the ink in the pressure chamber CV of the ejection section D.

The sealing substrate 15 for protecting the plurality of piezoelectric elements PZ1 and the plurality of piezoelectric elements PZ2 is provided at a position in the Z2 direction as viewed from the pressure chamber substrate 13, as illustrated in FIGS. 3 and 4. The sealing substrate 15 is a plate-shaped member elongated in the Y-axis direction and extending substantially parallel to the XY plane. The sealing substrate 15 is manufactured, for example, by processing a silicon single crystal substrate using a semiconductor manufacturing technique, but any known material and manufacturing method may be adopted to manufacture the sealing substrate 15.

As illustrated in FIG. 4, a surface of the sealing substrate 15 in the Z1 direction is provided with a recess for covering the plurality of piezoelectric elements PZ1 and a recess for covering the plurality of piezoelectric elements PZ2. Hereinafter, a sealing space covering the plurality of piezoelectric elements PZ1 and formed between the vibration plate 14 and the sealing substrate 15 is referred to as a sealing space SP1, and a sealing space covering the plurality of piezoelectric elements PZ2 and formed between the vibration plate 14 and the sealing substrate 15 is referred to as a sealing space SP2. In addition, the sealing spaces SP1 and SP2 are also referred to as sealing spaces SP without being particularly distinguished. The sealing spaces SP are spaces for sealing the piezoelectric elements PZ and preventing the piezoelectric elements PZ from deteriorating due to an effect of moisture or the like.

The sealing substrate 15 is provided with a through-hole 15h. The through-hole 15h is a hole that is located between the sealing space SP1 and the sealing space SP2 when the sealing substrate 15 is viewed in the Z1 direction and that penetrates from the surface of the sealing substrate 15 in the Z1 direction to a surface of the sealing substrate 15 in the Z2 direction. The wiring substrate 17 is inserted into the through-hole 15h.

The flow path forming substrate 16 is provided at a position in the Z2 direction as viewed from the communication plate 12, as illustrated in FIGS. 3 and 4. The flow path forming substrate 16 is a plate-shaped member elongated in the Y-axis direction and extending substantially parallel to the XY plane. The flow path forming substrate 16 is formed through, for example, injection molding of a resin material, but any known material and manufacturing method may be adopted to manufacture the flow path forming substrate 16.

As illustrated in FIG. 4, a flow path for ink is formed in the flow path forming substrate 16. Specifically, in the flow path forming substrate 16, one supply flow path BB1 and one supply flow path BB2 are formed. Among these, the supply flow path BB1 communicates with the supply flow path BA1 and extends in the Y-axis direction at a position in the Z2 direction as viewed from the supply flow path BA1. The supply flow path BB2 communicates with the supply flow path BA2 and extends in the Y-axis direction at a position in the Z2 direction as viewed from the supply flow path BA2 and in the X2 direction as viewed from the supply flow path BB1. The supply flow paths BB1 and BB2 are also referred to as supply flow paths BB without being particularly distinguished.

The flow path forming substrate 16 is provided with the inlet HL1 communicating with the supply flow path BB1 and the inlet HL2 communicating with the supply flow path BB2. The ink is supplied from the ink container 60 to the supply flow path BB1 through the inlet HL1. The ink supplied from the ink container 60 to the supply flow path BB1 through the inlet HL1 flows into the supply flow path BA1. A portion of the ink that has flowed into the supply flow path BA1 fills the pressure chambers CV1 via the coupling flow paths BK1. When the piezoelectric elements PZ1 are driven by the drive signal COM, the portion of the ink filling the pressure chambers CV1 is ejected from the nozzles NZ1 through the communication flow paths BR1.

In addition, the ink is supplied from the ink container 60 to the supply flow path BB2 through the inlet HL2. The ink supplied from the ink container 60 to the supply flow path BB2 through the inlet HL2 flows into the supply flow path BA2. A portion of the ink that has flowed into the supply flow path BA2 fills the pressure chambers CV2 through the coupling flow paths BK2. When the piezoelectric elements PZ2 are driven by the drive signal COM, the portion of the ink filling the pressure chambers CV2 is ejected from the nozzles NZ2 through the communication flow paths BR2.

The flow path forming substrate 16 is provided with a through-hole 16h. The through-hole 16h is a hole that is located between the supply flow path BB1 and the supply flow path BB2 when the flow path forming substrate 16 is viewed in the Z1 direction and that penetrates from a surface of the flow path forming substrate 16 in the Z1 direction to a surface of the flow path forming substrate 16 in the Z2 direction. The wiring substrate 17 is inserted into the through-hole 16h.

As illustrated in FIGS. 3 and 4, the wiring substrate 17 is mounted on the surface of the vibration plate 14 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably used. As described above, the electronic component EC including the switching circuit 18 and the detection circuit 19 is mounted on the wiring substrate 17.

As illustrated in FIGS. 3 and 4, at positions in the Z1 direction as viewed from the communication plate 12, the compliance sheet CS1 is provided to close the supply flow path BA1 and the coupling flow paths BK1, and the compliance sheet CS2 is provided to close the supply flow path BA2 and the coupling flow paths BK2. The compliance sheets CS1 and CS2 are also referred to as compliance sheets CS without being particularly distinguished. Each of the compliance sheets CS is a plate-shaped member elongated in the Y-axis direction and extending substantially parallel to the XY plane. The compliance sheets CS are formed of an elastic material and reduce fluctuations in pressure applied to ink in the supply flow paths BA and the coupling flow paths BK.

As illustrated in FIG. 4, an ejection section D1 includes a piezoelectric element PZ1, a pressure chamber CV1, a nozzle NZ1 communicating with the pressure chamber CV1, and a portion of the vibration plate 14 that is in contact with the piezoelectric element PZ1. Similarly, an ejection section D2 includes a piezoelectric element PZ2, a pressure chamber CV2, a nozzle NZ2 communicating with the pressure chamber CV2, and a portion of the vibration plate 14 that is in contact with the piezoelectric element PZ2. The ejection sections D1 and D2 are also referred to as ejection sections D without being particularly distinguished. In addition, a second element out of a first element and the second element included in one ejection section D is also referred to as the second element corresponding to the first element. Specifically, for example, a piezoelectric element PZ included in an ejection section D having a nozzle NZ is also referred to as the piezoelectric element PZ corresponding to the nozzle NZ.

In addition, although not illustrated, the liquid ejecting head 1 has a cap for sealing a nozzle surface which is a surface of the nozzle substrate 11 in the Z1 direction. The cap seals the nozzle surface of the nozzle substrate 11 in which the nozzles NZ are formed during a period of time when ink is not ejected from the nozzles NZ.

Next, an outline of the liquid ejecting head 1 will be described with reference to FIG. 5.

FIG. 5 is a block diagram illustrating an example of a configuration of the liquid ejecting head 1.

As described with reference to FIG. 1, the liquid ejecting head 1 includes the recording head 10, the switching circuit 18, and the detection circuit 19. Further, the liquid ejecting head 1 includes wiring La through which the drive signal COM is supplied from the drive signal generation unit 2, and wiring Ls through which a detection signal Vout is supplied to the detection circuit 19. In addition, the liquid ejecting head 1 includes wiring Li[k] through which the individual drive signal Vin[k] is supplied to the ejection section D[k] and wiring Ld to which the bias electrical potential VBS is supplied. In the present embodiment, it is assumed that the drive signal COM supplied to the wiring La is a drive signal COM for ejecting the ink from the nozzles NZ.

The switching circuit 18 includes K switches Swa[1] to Swa[K] corresponding to the K ejection sections D[1] to D[K] on a one-to-one basis and K switches SWs[1] to SWs[K] corresponding to the K ejection sections D[1] to D[K] on a one-to-one basis.

In addition, the switching circuit 18 includes a coupling state specifying circuit CSC. The coupling state specifying circuit CSC specifies a coupling state of each of the K switches SWa and the K switches SWs. For example, the coupling state specifying circuit CSC generates coupling state specifying signals Qa[k] and Qs[k] based on at least a signal included in the print signal SI and a latch signal LAT supplied from the control unit 4.

For example, the coupling state specifying signal Qa[k] is a signal for specifying whether to turn on or off the switch SWa[k], and the coupling state specifying signal Qs[k] is a signal for specifying whether to turn on or off the switch SWs[k].

The switch SWa[k] switches conduction and non-conduction between the wiring La and the individual electrode Za[k] of the piezoelectric element PZ[k] provided in the ejection section D[k] based on the coupling state specifying signal Qa[k]. That is, the switch SWa[k] switches conduction and non-conduction between the wiring La and the wiring Li[k] coupled to the individual electrode Za[k] based on the coupling state specifying signal Qa[k]. In the present embodiment, the switch SWa[k] is turned on when the coupling state specifying signal Qa[k] is at a high level, and is turned off when the coupling state specifying signal Qa[k] is at a low level. When the switch SWa[k] is turned on, the drive signal COM supplied to the wiring La is supplied as the individual drive signal Vin[k] to the individual electrode Za[k] of the ejection section D[k] through the wiring Li[k]. That is, the individual drive signal Vin[k] is the drive signal COM supplied to the piezoelectric element PZ[k] included in the ejection section D[k] through the switch SWa[k].

The switch SWs[k] switches conduction and non-conduction between the wiring Ls and the individual electrode Za[k] of the piezoelectric element PZ[k] provided in the ejection section D[k] based on the coupling state specifying signal Qs[k]. That is, the switch SWs[k] switches conduction and non-conduction between the wiring Ls and the wiring Li[k] coupled to the individual electrode Za[k] based on the coupling state specifying signal Qs[k]. In the present embodiment, the switch SWs[k] is turned on when the coupling state specifying signal Qs[k] is at a high level, and is turned off when the coupling state specifying signal Qs[k] is at a low level.

For example, the coupling state specifying signal Qs[k] is set to the high level when a residual vibration of the ejection section D[k] is to be detected. Hereinafter, an ejection section D in which a residual vibration is to be detected may be referred to as an ejection section D to be detected. In addition, hereinafter, a piezoelectric element PZ included in the ejection section D to be detected may be referred to as a piezoelectric element PZ to be detected. When the switch SWs[k] is turned on, a detection signal Vout[k] indicating the electrical potential of the individual electrode Za[k] of the piezoelectric element PZ[k] included in the ejection section D[k] to be detected is supplied to the detection circuit 19 through the wiring Li[k] and the wiring Ls. The detection circuit 19 generates a residual vibration signal VR[k] based on the detection signal Vout[k]. As described above, the residual vibration signal VR[k] is used for evaluation of electrical crosstalk.

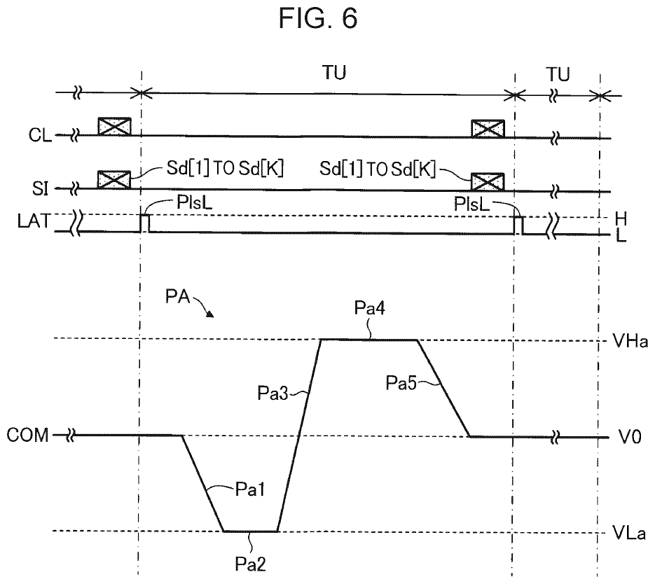

Next, an operation of the liquid ejecting apparatus 100 in a unit period TU will be described with reference to FIG. 6.

FIG. 6 is a timing chart illustrating an example of the operation of the liquid ejecting apparatus 100 in the unit period TU. In the present embodiment, when the liquid ejecting apparatus 100 performs the printing process, a printing process period including one or a plurality of unit periods TU is set as an operation period of the liquid ejecting apparatus 100. The liquid ejecting apparatus 100 according to the present embodiment can drive each of the ejection sections D for the printing process in each unit period TU. In addition, the liquid ejecting apparatus 100 according to the present embodiment can drive the ejection section D to be detected and can detect a detection signal Vout[k] from the ejection section D to be detected in each unit period TU.

FIG. 6 illustrates a waveform of the drive signal COM determined based on a result of evaluating electrical crosstalk.

The control unit 4 outputs the latch signal LAT having a pulse PlsL. Accordingly, the control unit 4 defines the unit period TU as a period from a rising edge of the pulse PlsL of the latch signal LAT to a next rising edge of the pulse PlsL of the latch signal LAT.

The print signal SI includes, for example, K individual specifying signals Sd[1] to Sd[K] corresponding to the K ejection sections D[1] to D[K] on a one to-one basis. The individual specifying signal Sd[k] specifies a drive mode of the ejection section D[k] in each unit period TU when the liquid ejecting apparatus 100 performs the printing process. The control unit 4 supplies the print signal SI including the individual specifying signals Sd[1] to Sd[K] to the coupling state specifying circuit CSC in synchronization with a clock signal CL before each unit period TU in which the printing process is performed. Then, the coupling state specifying circuit CSC generates the coupling state specifying signals Qa[k] and Qs[k] based on the individual specifying signal Sd[k] in the unit period TU.

For example, the ejection section D[k] is specified as any one of an ejection section D which forms a dot, an ejection section D which does not form a dot, and an ejection section D to be detected, by the individual specifying signal Sd[k] in the unit period TU in which the printing process is performed. The ejection section D which forms a dot is an ejection section D in which the piezoelectric element PZ of the ejection section D is driven such that ink is ejected from the nozzle NZ of the ejection section D. That is, the ejection section D which forms a dot is an ejection section D that is to be driven for ejection and in which the piezoelectric element PZ is driven by the drive signal COM for ejecting ink from the nozzle NZ. In addition, the ejection section D which does not form a dot is an ejection section D in which the piezoelectric element PZ of the ejection section D is driven such that ink is not ejected from the nozzle NZ of the ejection section D.

First, an operation of the coupling state specifying circuit CSC and the like when a drive mode as the ejection section D that forms a dot is specified by the individual specifying signal Sd[k] will be described. When the drive mode as the ejection section D which forms a dot is specified by the individual specifying signal Sd[k], for example, the coupling state specifying circuit CSC sets the coupling state specifying signal Qa[k] to the high level and the coupling state specifying signal Qs[k] to the low level in the unit period TU. Therefore, the drive signal COM is supplied from the drive signal generation unit 2 to the ejection section D which forms a dot.

For example, the drive signal generation unit 2 outputs the drive signal COM having a pulse PA. The pulse PA is, for example, a pulse for ejecting ink from the nozzle NZ. The pulse PA is a waveform in which the electrical potential of the drive signal COM changes from an electrical potential V0 through an electrical potential VLa lower than the electrical potential V0 and an electrical potential VHa higher than the electrical potential V0 to the electrical potential V0. The electrical potential V0 is an electrical potential at the start and end of the pulse PA, and is a reference electrical potential of the drive signal COM. Further, for example, the electrical potential VLa is the lowest electrical potential among the electrical potentials of the pulse PA and corresponds to an expansion electrical potential. Further, for example, the electrical potential VHa is the highest electrical potential among the electrical potentials of the pulse PA and corresponds to a contraction electrical potential.

For example, the pulse PA has a waveform element Pa1 in which the electrical potential is changed from the electrical potential V0 to the electrical potential VLa, a waveform element Pa2 in which the electrical potential is maintained at the electrical potential VLa at the end of the waveform element Pa1, and a waveform element Pa3 in which the electrical potential is changed from the electrical potential VLa to the electrical potential VHa. The pulse PA further includes a waveform element Pa4 in which the electrical potential is maintained at the electrical potential VHa at the end of the waveform element Pa3, and a waveform element Pa5 in which the electrical potential is changed from the electrical potential VHa to the electrical potential V0. Hereinafter, the waveform elements Pa1, Pa2, Pa3, Pa4, and Pa5 may be collectively referred to as waveform elements Pa.

The waveform elements Pa1 and Pa5 are expansion elements for deforming the piezoelectric bodies Zb in the Z2 direction. In the expansion elements, the electrical potential of the drive signal COM is changed for driving the piezoelectric elements PZ to expand volumes of the pressure chambers CV. Therefore, in the waveform elements Pa1 and Pa5, the electrical potential of the drive signal COM is changed to expand the volumes of the pressure chambers CV. When the volumes of the pressure chambers CV are expanded, the surfaces of the ink in the nozzles NZ are drawn in the Z2 direction which is a direction opposite to the ejection direction. Hereinafter, drawing the surfaces of the ink in the nozzles NZ in the direction opposite to the ejection direction may be referred to as pull. The waveform element Pa1 is an example of a “first expansion element”, and the waveform element Pa5 is an example of a “second expansion element”.

In addition, the waveform element Pa3 is a contraction element for deforming the piezoelectric bodies Zb in the Z1 direction. In the contraction element, the electrical potential of the drive signal COM is changed for driving the piezoelectric elements PZ to contract the volumes of the pressure chambers CV. Therefore, in the waveform element Pa3, the electrical potential of the drive signal COM is changed to contract the volumes of the pressure chambers CV. When the volumes of the pressure chambers CV are contracted, the surfaces of the ink in the nozzles NZ are pushed out in the Z1 direction which is the ejection direction. Hereinafter, pushing out the surfaces of the ink in the nozzles NZ in the ejection direction may be referred to as push.

In addition, the waveform elements Pa2 and Pa4 are maintained elements for maintaining the positions of the piezoelectric bodies Zb in the Z-axis direction. For example, in the waveform element Pa2, the electrical potential of the drive signal COM is maintained for driving the piezoelectric elements PZ to maintain the volumes of the pressure chambers CV expanded by the waveform element Pa1. In addition, for example, in the waveform element Pa4, the electrical potential of the drive signal COM is maintained for driving the piezoelectric elements PZ to maintain the volumes of the pressure chambers CV contracted by the waveform element Pa3.

As described above, the pulse PA is a so-called pull-push-pull waveform. However, the waveform of the drive signal COM for ejecting the ink from the nozzles NZ is not limited to the pull-push-pull waveform. For example, a so-called pull-push waveform may be used, which causes the ink to be drawn in the Z2 direction in the pressure chambers CV by expanding the pressure chambers CV by a first expansion element, causes the ink to be ejected from the pressure chambers CV in the Z1 direction by contracting the pressure chambers CV by a contraction element in which the electrical potential returns to the electrical potential before the application of the first expansion component, and does not cause a second expansion element to be applied after the contraction element.

The pulse PA is determined such that a predetermined amount of ink is ejected from the ejection section D[k] when the individual drive signal Vin[k] having the pulse PA is supplied to the ejection section D[k]. In the present embodiment, it is assumed that, when the electrical potential of the individual drive signal Vin[k] is a high electrical potential, the volume of the pressure chamber CV included in the ejection section D[k] is smaller than that when the electrical potential of the individual drive signal Vin[k] is a low electrical potential. Therefore, when the ejection section D[k] is driven by the individual drive signal Vin[k] having the pulse PA, the ink in the ejection section D[k] is ejected from the nozzle NZ by the waveform element Pa3 in which the electrical potential of the individual drive signal Vin[k] changes from the low electrical potential to the high electrical potential.

For example, the waveform elements Pa1, Pa2, Pa3, Pa4, and Pa5 included in the pulse PA are determined based on characteristics of ejection of ink by the ejection sections D and the like. The characteristics of ejection of ink are, for example, an amount of ink ejected as an ink droplet, the speed at which the ink droplet is ejected, and the like. Further, in the present embodiment, a rate of change in the electrical potential of the pulse PA is determined so as to suppress the occurrence of electrical crosstalk. The rate of change in the electrical potential is the amount of change in the electrical potential per unit time. For example, electrical crosstalk occurs due to an effect of a resistance component, a capacitance component, and an inductance component of the wiring La or the like to which the drive signal COM is supplied. Therefore, it is considered that a waveform element Pa in which an electrical potential largely changes has a larger effect on the occurrence of electrical crosstalk than a waveform element Pa in which an electrical potential slightly changes. For example, in the pulse PA illustrated in FIG. 6, among the waveform elements Pa1, Pa2, Pa3, Pa4, and Pa5, the waveform element Pa3 in which the amount of change in the electrical potential is the largest is considered to have the largest effect on the occurrence of electrical crosstalk. Therefore, in the present embodiment, the occurrence of electrical crosstalk is suppressed by adjusting a rate of change in the electrical potential of the waveform element Pa3. Note that the rate of change in the electrical potential adjusted to suppress the occurrence of electrical crosstalk is not limited to the rate of change in the electrical potential of the waveform element Pa3 as long as the occurrence of electrical crosstalk can be suppressed. For example, in addition to the rate of change in the electrical potential of the waveform element Pa3, one or both of a rate of change in the electrical potential of the waveform element Pa1 and a rate of change in the electrical potential of the waveform element Pa2 may be adjusted.

Next, an operation of the coupling state specifying circuit CSC and the like when a drive mode as the ejection section D which does not form a dot is specified by the individual specifying signal Sd[k] will be described. When the drive mode as the ejection section D which does not form a dot is specified by the individual specifying signal Sd[k], for example, the coupling state specifying circuit CSC sets each of the coupling state specifying signals Qa[k] and Qs[k] to the low level in the unit period TU. Accordingly, when a leakage current does not occur, the electrical potential of the individual electrode Za of the piezoelectric element PZ included in the ejection section D that does not form a dot is maintained at the electrical potential before the coupling state specifying signal Qa[k] is set to the low level, for example, at the electrical potential V0.

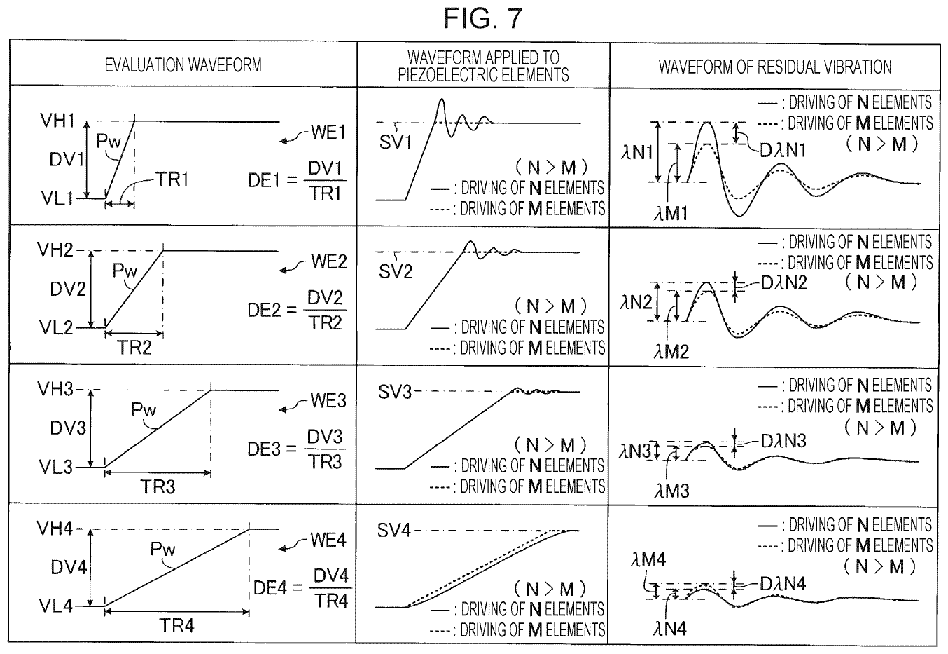

Next, an operation of the coupling state specifying circuit CSC and the like when a drive mode as the ejection section D to be detected is specified by the individual specifying signal Sd[k] will be described. The operation of the coupling state specifying circuit CSC and the like when the drive mode as the ejection section D to be detected is specified by the individual specifying signal Sd[k] will be described by exemplifying a case where electrical crosstalk is evaluated. Hereinafter, a unit period TU in which a residual vibration for evaluating electrical crosstalk is detected may be referred to as a unit period TU for detection. When electrical crosstalk is to be evaluated, for example, the ejection section D to be detected operates as an ejection section D driven by a drive signal COM for evaluation in a unit period TU immediately before the unit period TU for detection. That is, the piezoelectric element PZ included in the ejection section D to be detected is driven by an evaluation waveform which is a waveform of the drive signal COM for evaluation in the unit period TU immediately before the unit period TU for detection. Details of the evaluation waveform will be described later with reference to FIG. 7, and as the evaluation waveform, for example, a plurality of evaluation waveforms in which electrical potentials change at different rates in waveform elements Pa3 are used. Further, in the present embodiment, it is assumed that each of a plurality of drive signals COM for evaluation each having a plurality of evaluation waveforms is a drive signal COM for ejecting ink from the nozzles NZ. Therefore, when the ejection section D to be detected is to be driven by the drive signal COM for evaluation, for example, it is preferable that the ejection section D to be detected is positioned on an ejected ink receiving section which is used in the flushing process.

When the drive mode as the ejection section D to be detected is specified by the individual specifying signal Sd[k], for example, the coupling state specifying circuit CSC sets the coupling state specifying signal Qa[k] to the high level and the coupling state specifying signal Qs[k] to the low level in the unit period TU immediately before the unit period TU for detection.

In addition, in the evaluation of electrical crosstalk, a specific ejection section D other than the ejection section D to be ejected may be specified by an individual specifying signal Sd[j] as the ejection section D which is driven by the drive signal COM for evaluation. The variable j is a natural number different from the variable k and satisfies “1≤j≤k”. In the unit period TU immediately before the unit period TU for detection, coupling state specifying signals Qa[j] and Qs[j] corresponding to the above-described specific ejection section D are set in a similar manner to the coupling state specifying signals Qa[k] and Qs[k].

Accordingly, the drive signal COM for evaluation is supplied from the drive signal generation unit 2 to the ejection section D to be detected and the specific ejection section D. Then, the coupling state specifying circuit CSC sets the coupling state specifying signal Qs[k] to the high level in the unit period TU for detection. In addition, the coupling state specifying circuit CSC sets the coupling state specifying signal Qa[k] to the low level in the unit period TU for detection. In addition, in the unit period TU for detection, each of the coupling state specifying signals Qa[j] and Qs[j] is set to a low level.

In this case, the piezoelectric element PZ[k] included in each of the ejection section D[k] to be detected and the specific ejection section D[j] is driven by the drive signal COM for evaluation in the unit period TU immediately before the unit period TU for detection. Accordingly, for example, the piezoelectric element PZ[k] is deformed by the pulse PA of the drive signal COM for evaluation in the unit period TU immediately before the unit period TU for detection. As a result, a vibration is generated in the ejection section D[k] to be detected before the unit period TU for detection. The vibration generated before the unit period TU for detection also remains in the unit period TU for detection. Then, in the unit period TU for detection, the electrical potential of the individual electrode Za[k] of the piezoelectric element PZ[k] included in the ejection section D[k] to be detected changes according to the residual vibration generated in the ejection section D[k]. That is, in the unit period TU for detection, the electrical potential of the individual electrode Za of the piezoelectric element PZ included in the ejection section D to be detected becomes an electrical potential corresponding to an electromotive force of the piezoelectric element PZ caused by the residual vibration generated in the ejection section D to be detected. Then, the electrical potential of the individual electrode Za is detected as the detection signal Vout in the unit period TU for detection.

For example, the coupling state specifying circuit CSC may set the coupling state specifying signal Qs[k] to the high level in the first half period of the unit period TU for detection, and may set the coupling state specifying signal Qs[k] to the low level in the second half period of the unit period TU for detection. In addition, for example, each of the coupling state specifying signals Qa and Qs corresponding to the ejection sections D other than the ejection section D[k] to be detected is set to the low level in the unit period TU for detection.

As described above, in the present embodiment, for example, the residual vibration signal VR[k] indicating a residual vibration of the vibration plate 14 after the piezoelectric element PZ is driven by the drive signal COM for evaluation is used for the evaluation of electrical crosstalk.

The operation of the liquid ejecting apparatus 100 is not limited to the example illustrated in FIG. 6. For example, in FIG. 6, the drive signal COM including one pulse PA for ejecting the ink from the nozzles NZ is exemplified, but the present disclosure is not limited to such an aspect. For example, the drive signal COM may have a plurality of pulses for ejecting the ink for forming dots having different sizes from the nozzles NZ. In addition, for example, in FIG. 6, a case where the number of drive signals COM for ejecting the ink from the nozzles NZ is one is exemplified, but the present disclosure is not limited to such an aspect. For example, a plurality of drive signals COM corresponding to the sizes of dots may be used as the drive signal COM for ejecting the ink from the nozzles NZ. The plurality of drive signals COM may include one or both of a drive signal COM having a minute vibration waveform for preventing thickening of the ink and a drive signal COM having a minute vibration waveform for generating a residual vibration for evaluating an ejection state.

In addition, the evaluation waveform for evaluation of electrical crosstalk, that is, the waveform of the drive signal COM for evaluation may be different from a waveform which is actually used as the waveform of the drive signal COM for ejecting the ink from the nozzles NZ. For example, when the waveform used as the waveform of the drive signal COM for ejecting the ink from the nozzles NZ is a pull-push-pull waveform, a rectangular wave in which an electrical potential returns to the electrical potential VLa from the electrical potential VLa through the electrical potential VHa may be used as the evaluation waveform.

Next, an example of a relationship between the evaluation waveform and the waveform of the residual vibration will be described with reference to FIG. 7.

FIG. 7 is a diagram illustrating an example of the evaluation waveform and the waveform of the residual vibration. FIG. 7 illustrates four evaluation waveforms WE1, WE2, WE3, and WE4, waveforms applied to the piezoelectric elements PZ when the piezoelectric elements PZ are driven by the respective evaluation waveforms WE1, WE2, WE3, and WE4, and waveforms of detected residual vibrations. The waveforms of the detected residual vibrations are, for example, waveforms of residual vibration signals VR.

In FIG. 7, waveforms applied to N piezoelectric elements PZ and waveforms of detected residual vibrations when only the N piezoelectric elements PZ are driven are indicated by solid lines, and waveforms applied to M piezoelectric elements PZ and waveforms of detected residual vibrations when only the M piezoelectric elements PZ are driven are indicated by dotted lines. Although FIG. 7 illustrates a case where all the piezoelectric elements PZ are driven and a case where only one of the piezoelectric elements PZ is driven, similar tendencies to those in FIG. 7 are obtained even when only the N piezoelectric elements among all the piezoelectric elements are driven instead of all the piezoelectric elements and only the M piezoelectric elements among all the piezoelectric elements are driven instead of one of the piezoelectric elements Pz. In this case, N satisfies “2≤N≤K” and M satisfies “1≤M<N”.

Therefore, hereinafter, driving of only the N piezoelectric elements PZ among the K piezoelectric elements PZ (including driving of all of the K piezoelectric elements PZ) may be referred to as driving of the N elements, and driving of only the M piezoelectric elements PZ among the K piezoelectric elements PZ (including driving of only one of the K piezoelectric elements PZ) may be referred to as driving of the M elements.

Hereinafter, the evaluation waveforms WE1, WE2, WE3, and WE4 may be collectively referred to as evaluation waveforms WE. In the present embodiment, it is assumed that each of the evaluation waveforms WE is a pull-push-pull waveform similarly to the pulse PA illustrated in FIG. 6, but each of the evaluation waveforms WE may be, for example, a rectangular wave including a waveform element Pw or such a pull-push waveform as described above. In order to make the drawing easy to see, FIG. 7 illustrates each of the evaluation waveforms WE while focusing on a waveform element Pw corresponding to the push of the pull-push-pull waveform, and illustration of a portion of the pull-push-pull waveform is omitted in FIG. 7. The waveform element Pw of each of the evaluation waveforms WE corresponds to the waveform element Pa3 of the pulse PA illustrated in FIG. 6.

Hereinafter, a rate DE1 of change in the electrical potential of the waveform element Pw of the evaluation waveform WE1, a rate DE2 of change in the electrical potential of the waveform element Pw of the evaluation waveform WE2, a rate DE3 of change in the electrical potential of the waveform element Pw of the evaluation waveform WE3, and a rate DE4 of change in the electrical potential of the waveform element Pw of the evaluation waveform WE4 may be collectively referred to as rates DE of change in the electrical potentials. The rates DE of change in the electrical potentials of the evaluation waveforms WE1, WE2, WE3, and WE4 illustrated in FIG. 7 are different from each other.

The rates DE1, DE2, DE3, and DE4 of change in the electrical potentials are expressed by Equations (1), (2), (3), and (4), respectively.

$$DE 1 = \vert VH 1 - VL 1 \vert / TR 1 = DV 1 / TR 1 \qquad ( 1 )$$

$$DE 2 = \vert VH 2 - VL 2 \vert / TR 2 = DV 2 / TR 2 \qquad ( 2 )$$

$$DE 3 = \vert VH 3 - VL 3 \vert / TR 3 = DV 3 / TR 3 \qquad ( 3 )$$

$$DE 4 = \vert VH 4 - VL 4 \vert / TR 4 = DV 4 / TR 4 \qquad ( 4 )$$

The electrical potential difference DV1 in Equation (1) indicates the absolute value of the difference between the electrical potential VL1 at the start point of the waveform element Pw of the evaluation waveform WE1 and the electrical potential VH1 at the end point of the waveform element Pw of the evaluation waveform WE1, and the period of time TR1 indicates a period of time from the start point to the end point of the waveform element Pw of the evaluation waveform WE1. The electrical potential difference DV2 in Equation (2) indicates the absolute value of the difference between the electrical potential VL2 at the start point of the waveform element Pw of the evaluation waveform WE2 and the electrical potential VH2 at the end point of the waveform element Pw of the evaluation waveform WE2, and the period of time TR2 indicates a period of time from the start point to the end point of the waveform element Pw of the evaluation waveform WE2. The electrical potential difference DV3 in Equation (3) indicates the absolute value of the difference between the electrical potential VL3 at the start point of the waveform element Pw of the evaluation waveform WE3 and the electrical potential VH3 at the end point of the waveform element Pw of the evaluation waveform WE3, and the period of time TR3 indicates a period of time from the start point to the end point of the waveform element Pw of the evaluation waveform WE3. The electrical potential difference DV4 in Equation (4) indicates the absolute value of the difference between the electrical potential VL4 at the start point of the waveform element Pw of the evaluation waveform WE4 and the electrical potential VH4 at the end point of the waveform element Pw of the evaluation waveform WE4, and the period of time TR4 indicates a period of time from the start point to the end point of the waveform element Pw of the evaluation waveform WE4. Hereinafter, the periods of time TR1, TR2, TR3, and TR4 may be collectively referred to as periods of time TR.

In the example illustrated in FIG. 7, the electrical potentials VL1, VL2, VL3, and VL4 are equal to each other, for example, are the electrical potential VLa, and the electrical potentials VH1, VH2, VH3, and VH4 are equal to each other, for example, are the electrical potential VHa. Therefore, the electrical potential differences DV1, DV2, DV3, and DV4 are equal to each other. In the following description, the electrical potentials VL1, VL2, VL3, VL4, and VLa may be collectively referred to as electrical potentials VL, the electrical potentials VH1, VH2, VH3, VH4, and VHa may be collectively referred to as electrical potentials VH, and the electrical potential differences DV1, DV2, DV3, and DV4 may be collectively referred to as electrical potential differences DV. Among the periods of time TR1, TR2, TR3, and TR4, the period of time TR1 is the shortest, and the period of time TR4 is the longest. The period of time TR2 is longer than the period of time TR1, and the period of time TR3 is longer than the period of time TR2.

Therefore, in the example illustrated in FIG. 7, among the rates DE1, DE2, DE3, and DE4 of change in the electrical potentials, the rate DE1 of change in the electrical potential is the highest, and the rate DE4 of change in the electrical potential is the lowest. The rate DE2 of change in the electrical potential is lower than the rate DE1 of change in the electrical potential, and the rate DE3 of change in the electrical potential is lower than the rate DE2 of change in the electrical potential. The rate DE1 of change in the electrical potential is an example of a “first electrical potential change rate”, the rate DE2 of change in the electrical potential is an example of a “second rate electrical potential change rate”, and the rate DE3 of change in the electrical potential is an example of a “third electrical potential change rate”. The evaluation waveform WE1 is an example of a “first evaluation waveform”, the evaluation waveform WE2 is an example of a “second evaluation waveform”, and the evaluation waveform WE3 is an example of a “third evaluation waveform”. Further, the waveform element Pw of the evaluation waveform WE1 is an example of a “first waveform element”, and the waveform element Pw of the evaluation waveform WE2 is an example of a “second waveform element”.

When a rate DE of change in an electrical potential is high, the inclination of a waveform element Pw is steeper than that when the rate DE of change in the electrical potential is low. When the piezoelectric element PZ is driven with a waveform having a steep change in an electrical potential, overshoot in which an electrical potential higher than a steady value corresponding to the electrical potential at the end point of the change in the electrical potential is applied to the piezoelectric element PZ may occur due to an effect of a resistance component, a capacitance component, and an inductance component of the switching circuit 18, the wiring La, or the like. An effect in which overshoot occurs in a waveform due to the effect of the resistance component, the capacitance component, and the inductance component of the wiring La or the like is one type of electrical crosstalk. Hereinafter, the difference between the electrical potential exceeding the steady value and the steady value is referred to as the magnitude of the overshoot, and the magnitude of the overshoot will be described in some cases.

For example, as illustrated in “waveform applied to piezoelectric elements” in FIG. 7, when the N piezoelectric elements are driven by the evaluation waveform WE1, overshoot in which the electrical potential becomes higher than a steady value SV1 and then approaches the steady value SV1 occurs in the waveform applied to the piezoelectric elements PZ. The steady value SV1 is an electrical potential corresponding to the electrical potential VH1 at the end point of the waveform element Pw.

The overshoot depends on, for example, the amount of current flowing through the wiring La or the like. For example, when the number of piezoelectric elements PZ driven is large, the amount of current flowing through the wiring La is larger than that when the number of piezoelectric elements PZ driven is small. Therefore, the overshoot tends to increase in magnitude as the number of piezoelectric elements PZ driven increases. In other words, when the number of piezoelectric elements PZ driven is small, the occurrence of overshoot is suppressed. For example, as illustrated in “waveform applied to piezoelectric elements” in FIG. 7, in each of the evaluation waveforms WE1, WE2, WE3, and WE4, overshoot does not occur in the waveform applied to the piezoelectric elements PZ when the M piezoelectric devices are driven.

When overshoot occurs in a waveform applied to the piezoelectric elements PZ, the piezoelectric elements PZ are deformed according to the overshoot. Therefore, compared with a case where overshoot does not occur, a large vibration occurs in the vibration plate 14. Therefore, when overshoot occurs in the waveform applied to the piezoelectric elements PZ, a large ink droplet is ejected. If the magnitude of the overshoot is excessively large, a voltage exceeding the withstand voltage of the piezoelectric elements PZ is applied to the piezoelectric elements PZ, and the piezoelectric elements PZ may malfunction.

In addition, when the overshoot occurs, as described above, the piezoelectric elements PZ are deformed according to the overshoot, a residual vibration occurs according to the overshoot. For example, when the overshoot occurs, a large vibration occurs in the vibration plate 14 compared with a case where the overshoot does not occur, and thus the amplitude of the residual vibration also increases. Therefore, it is possible to estimate the magnitude of the overshoot by examining the relationship between the number of piezoelectric elements PZ driven and the residual vibration. For example, the analyzer 3 identifies the amplitude of the first peak among peaks of an electrical potential of a residual vibration signal VR as the amplitude of the residual vibration of the vibration plate 14.

For example, as illustrated in “waveform of residual vibration” in FIG. 7, an amplitude λN1 of a residual vibration detected when the N piezoelectric elements are driven by the evaluation waveform WE1 is greater than an amplitude λM1 of a residual vibration detected when the M piezoelectric elements are driven by the evaluation waveform WE1. That is, the amplitude λN1 of the residual vibration when overshoot occurs is greater than the amplitude λM1 of the residual vibration when overshoot does not occur. A difference DλN1 between the amplitudes is a value obtained by subtracting the amplitude λN1 from the amplitude λM1, and is an evaluation value to be compared with thresholds used for evaluation of electrical crosstalk. The residual vibration detected when the N piezoelectric elements are driven by the evaluation waveform WE1 is an example of a “first residual vibration”, the residual vibration detected when the M piezoelectric elements are driven by the evaluation waveform WE1 is an example of a “first reference residual vibration”, and the difference DλN1 between the amplitudes is an example of a “first amplitude difference”. A residual vibration detected when the M piezoelectric elements are driven with each evaluation waveform WE corresponds to a “reference residual vibration”.

Further, the overshoot tends to increase in magnitude as a change in the electrical potential becomes steeper. That is, the overshoot tends to increase in magnitude as the rate DE of change in the electrical potential increases. For example, when the rate DE of change in the electrical potential is high, the overshoot increases in magnitude, compared with a case where the rate DE of change in the electrical potential is low. In other words, when the rate DE of change in the electrical potential is low, the overshoot decreases in magnitude, compared with a case where the rate DE of change in the electrical potential is high.

For example, the rate DE2 of change in the electrical potential of the waveform element Pw of the evaluation waveform WE2 is lower than the rate DE1 of change in the electrical potential of the waveform element Pw of the evaluation waveform WE1. Therefore, as illustrated in “waveform applied to piezoelectric elements” in FIG. 7, the magnitude of overshoot which occurs when the N piezoelectric elements are driven by the evaluation waveform WE2 is less than the magnitude of overshoot which occurs when the N piezoelectric elements are driven by the evaluation waveform WE1. A steady value SV2 is an electrical potential corresponding to the electrical potential VH2 at the end point of the waveform element Pw of the evaluation waveform WE2. In addition, as illustrated in “waveform of residual vibration” in FIG. 7, a difference DλN2 between an amplitude λN2 of a residual vibration detected when the N piezoelectric elements are driven by the evaluation waveform WE2 and an amplitude λM2 of a residual vibration detected when the M piezoelectric elements are driven by the evaluation waveform WE2 is less than the amplitude difference DλN1. The difference DλN2 between the amplitudes is a value obtained by subtracting the amplitude λM2 from the amplitude λN2, and is an evaluation value to be compared with the thresholds used for evaluation of electrical crosstalk. In addition, for example, the amplitude λN2 of the residual vibration detected when the N piezoelectric elements are driven by the evaluation waveform WE2 is less than the amplitude λN1 of the residual vibration detected when the N piezoelectric elements are driven by the evaluation waveform WE1. The residual vibration detected when the N piezoelectric elements are driven by the evaluation waveform WE2 is an example of a “second residual vibration”, the residual vibration detected when the M piezoelectric elements are driven by the evaluation waveform WE2 is an example of a “second reference residual vibration”, and the difference DλN2 between the amplitudes is an example of a “second amplitude difference”.

Further, for example, the rate DE3 of change in the electrical potential of the waveform element Pw of the evaluation waveform WE3 is lower than the rate DE2 of change in the electrical potential of the waveform element Pw of the evaluation waveform WE2. Therefore, as illustrated in “waveform applied to piezoelectric elements” in FIG. 7, the magnitude of overshoot which occurs when the N piezoelectric elements are driven by the evaluation waveform WE3 is less than the magnitude of overshoot which occurs when the N piezoelectric elements are driven by the evaluation waveform WE2. A steady value SV3 is an electrical potential corresponding to the electrical potential VH3 at the end point of the waveform element Pw of the evaluation waveform WE3. In addition, as illustrated in “waveform of residual vibration” in FIG. 7, a difference DλN3 between an amplitude λN3 of a residual vibration detected when the N piezoelectric elements are driven by the evaluation waveform WE3 and an amplitude λM3 of a residual vibration detected when the M piezoelectric elements are driven by the evaluation waveform WE3 are less than the difference DλN2. The difference DλN3 between the amplitudes is a value obtained by subtracting the amplitude λM3 from the amplitude λN3, and is an evaluation value to be compared with the thresholds used for evaluation of electrical crosstalk. In addition, for example, the amplitude λN3 of the residual vibration detected when the N piezoelectric elements are driven by the evaluation waveform WE3 is less than the amplitude λN2 of the residual vibration detected when the N piezoelectric elements are driven by the evaluation waveform WE2. The residual vibration detected when the N piezoelectric elements are driven by the evaluation waveform WE3 is an example of a “third residual vibration”.

When a rate DE of change in an electrical potential becomes too low, the occurrence of overshoot is suppressed, but the waveform applied to the piezoelectric elements PZ is dull due to the effect of the resistance component, the capacitance component, and the inductance component of the wiring La or the like. The occurrence of the dullness in the waveform indicates, for example, that a change in the electrical potential becomes gradual when the electrical potential changes from an electrical potential corresponding to the electrical potential at the start point of the change in the electrical potential to a steady value which is an electrical potential corresponding to the electrical potential at the end point of the change in the electrical potential. An effect in which a waveform becomes dull due to the effect of the resistance component, the capacitance component, and the inductance component of the wiring La or the like is also one type of electrical crosstalk. When the waveform applied to the piezoelectric elements PZ becomes dull, the characteristics of ejection of ink may not be desired characteristics.

For example, the rate DE4 of change in the electrical potential of the waveform element Pw of the evaluation waveform WE4 is the lowest among the rates DE1, DE2, DE3, and DE4 of change in the electrical potentials. Therefore, for example, as illustrated in “waveform applied to piezoelectric elements” in FIG. 7, when the N piezoelectric elements are driven by the evaluation waveform WE4, the waveform applied to the piezoelectric elements PZ becomes dull. For example, when the electrical potential changes from the electrical potential corresponding to the electrical potential VL4 at the start point of the waveform element Pw to a steady value SV4 which is an electrical potential corresponding to the electrical potential VH4 at the end point of the waveform element Pw, the change in the electrical potential is gradual. It should be noted that when the M piezoelectric elements are driven by the evaluation waveform WE4, the waveform applied to the piezoelectric elements PZ does not become dull. When dullness occurs in the waveform applied to the piezoelectric elements PZ, the amplitude of the residual vibration tends to be less than that when dullness does not occur.

For example, as illustrated in “waveform of residual vibration” in FIG. 7, an amplitude λN4 of a residual vibration detected when the N piezoelectric elements are driven by the evaluation waveform WE4 is less than an amplitude λM4 of a residual vibration detected when the M piezoelectric elements are driven by the evaluation waveform WE4. That is, the amplitude λN4 of the residual vibration when the waveform applied to the piezoelectric elements PZ becomes dull is less than the amplitude λM4 of the residual vibration when the waveform applied to the piezoelectric elements PZ does not become dull. A difference DλN4 between the amplitudes is a value obtained by subtracting the amplitude λM4 from the amplitude λN4, and is an evaluation value to be compared with the thresholds used for evaluation of electrical crosstalk. In the example illustrated in FIG. 7, since the amplitude λN4 is less than the amplitude λM4, the difference DλN4 between the amplitudes is a negative value.

Hereinafter, the amplitudes λN1, λN2, λN3, and λN4 may be collectively referred to as amplitudes λN, the amplitudes λM1, λM2, λM3, and λM4 may be collectively referred to as amplitudes λM, and the difference DλN1, DλN2, DλN3, and DλN4 between the amplitudes may be collectively referred to as differences DλN between the amplitudes.

As illustrated in FIG. 7, when overshoot occurs when the N piezoelectric elements are driven, the amplitudes λN are greater than the amplitudes λM, and thus the differences DλN between the amplitudes are positive values. On the other hand, when dullness occurs when the N piezoelectric elements are driven, the amplitudes λN are less than the amplitudes λM, and thus the differences DλN between the amplitudes are negative values.

In the present embodiment, for example, the waveform determining section 40 evaluates electrical crosstalk by comparing the thresholds with each of a plurality of differences DλN between amplitudes obtained by driving the piezoelectric elements PZ with each of a plurality of evaluation waveforms WE having different rates DE of change in electrical potentials of waveform elements Pw. Then, for example, the waveform determining section 40 determines the waveform of the drive signal COM defined by the waveform specifying signal dCOM based on a result of evaluating the electrical crosstalk.

FIG. 7 illustrates a case where the plurality of electrical potential differences DV corresponding to the plurality of rates DE of change in the electrical potentials are equal to each other and the plurality of periods of time TR corresponding to the plurality of rates DE of change in the electrical potentials are different from each other, but the present disclosure is not limited to such an aspect. That is, the method of making the plurality of rates DE of change in the electrical potentials different from each other is not limited to the example illustrated in FIG. 7. For example, the electrical potential differences DV1, DV2, DV3, and DV4 may be set to be different from each other, the periods of time TR1, TR2, TR3, and TR4 may be set to be equal to each other, and thus the rates DE1, DE2, DE3, and DE4 of change in the electrical potentials may be set to be different from each other.

Further, the effect of electrical crosstalk when the M piezoelectric elements are driven is smaller than that when the N piezoelectric elements are driven. Therefore, a variation in the amplitudes λM of residual vibrations detected when the M piezoelectric elements are driven by the plurality of evaluation waveforms WE in which the rates DE of change in the electrical potentials of the waveform elements Pw are different tends to be less than a variation in the amplitudes λN of residual vibrations detected when the N piezoelectric elements are driven by the plurality of evaluation waveforms WE. Therefore, the amplitude difference DλN used as an evaluation value for each evaluation waveform WE may be calculated by subtracting a reference value common to the plurality of evaluation waveforms WE from an amplitude λN of a residual vibration detected when the N piezoelectric elements are driven.

Next, an operation of the liquid ejecting apparatus 100 for determination of the waveform of the drive signal COM will be described with reference to FIG. 8.

FIG. 8 is a flowchart illustrating an example of the operation of the liquid ejecting apparatus 100 for determination of the waveform of the drive signal COM. In FIG. 8, in accordance with FIG. 7, it is assumed that the value N is equal to the value K and the value M is “1”. Note that the N piezoelectric elements PZ and the M piezoelectric elements PZ include a piezoelectric element PZ that is to be detected and from which a residual vibration is detected.

In FIG. 8, it is assumed that a plurality of evaluation waveforms WE in which rates DE of change in electrical potentials of waveform elements Pw corresponding to the waveform element PA3 of the pulse PA are different from each other are prepared before the operation illustrated in FIG. 8 is executed. Meanwhile, the plurality of evaluation waveforms WE may be generated during the operation illustrated in FIG. 8. For example, the plurality of evaluation waveforms WE may be generated during the operation illustrated in FIG. 8 by changing a rate DE of change in an electrical potential of a waveform element Pw of a basic evaluation waveform WE every time processing in step S152 described later is executed.

In addition, the timing at which the operation illustrated in FIG. 8 is executed is not particularly limited, but the operation is preferably executed when the liquid ejecting apparatus 100 is used for the first time, or when a usage condition of the liquid ejecting apparatus 100 is changed due to a change in the type of ink to be used. The usage condition of the liquid ejecting apparatus 100 also includes a usage condition of the liquid ejecting head 1. The operation illustrated in FIG. 8 is executed on each of the plurality of liquid ejecting heads 1, for example. In addition, a piezoelectric element PZ that is to be detected and is used for evaluation of electrical crosstalk in the determination of the waveform of the drive signal COM represents the plurality of piezoelectric elements PZ.

The operation illustrated in FIG. 8 is executed by the control unit 4 that functions as the waveform determining section 40. That is, the control unit 4 functions as the waveform determining section 40 in each of steps from step S100 to step S152 illustrated in FIG. 8 and in step S200. A process in step S100 is executed, for example, in a state where ink to be used by a user of the liquid ejecting apparatus 100 fills the pressure chambers CV. That is, after the ink used by the user fills the pressure chambers CV, the process in step S100 is executed. A process of filling the pressure chambers CV with the ink may be executed by the waveform determining section 40, or may be executed by a processing section other than the waveform determining section 40. The user is, for example, the user of the liquid ejecting apparatus 100. In addition, when a manufacturer of the liquid ejecting apparatus 100 and the user of the liquid ejecting apparatus 100 are the same, the manufacturer of the liquid ejecting apparatus 100 may be considered as the user.

First, in step S100, the waveform determining section 40 sets the variable i to “1”. After executing the process in step S100, the waveform determining section 40 causes the process to proceed to step S110.

In step S110, the waveform determining section 40 controls the liquid ejecting head 1 so as to drive the N piezoelectric elements with the i-th evaluation waveform WEi. For example, the waveform determining section 40 selects a signal having the i-th evaluation waveform WEi as the drive signal COM, and controls the liquid ejecting head 1 such that all of the K piezoelectric elements PZ are driven using the selected drive signal COM.

Next, in step S120, the waveform determining section 40 detects a residual vibration in a piezoelectric element PZ to be detected. For example, the waveform determining section 40 causes the detection circuit 19 to detect the residual vibration from the piezoelectric element PZ to be detected. Accordingly, the residual vibration of the vibration plate 14 after the N piezoelectric elements PZ are driven with the i-th evaluation waveform WEi is detected by the detection circuit 19. Then, the residual vibration detected by the detection circuit 19 is analyzed by the analyzer 3. The waveform determining section 40 acquires, from the analyzer 3, residual vibration information Vinf indicating an analysis result of the residual vibration detected by the detection circuit 19. For example, the analysis result indicated by the residual vibration information ViNf includes the amplitude λN of the residual vibration detected when the N piezoelectric elements PZ are driven with the i-th evaluation waveform WEi. When the i-th evaluation waveform WEi corresponds to the “first evaluation waveform”, the residual vibration detected in step S120 is an example of the “first residual vibration”. Further, when the i-th evaluation waveform WEi corresponds to the “second evaluation waveform”, the residual vibration detected in step S120 is an example of the “second residual vibration”. Further, when the i-th evaluation waveform WEi corresponds to the “third evaluation waveform”, the residual vibration detected in step S120 is an example of the “third residual vibration”.

Next, in step S130, the waveform determining section 40 controls the liquid ejecting head 1 so as to drive the M piezoelectric elements with the i-th evaluation waveform WEi. For example, the waveform determining section 40 selects the signal of the i-th evaluation waveform WEi as the drive signal COM, and controls the liquid ejecting head 1 such that only one piezoelectric element PZ among the K piezoelectric elements PZ is driven using the selected drive signal COM.

Next, in step S140, the waveform determining section 40 detects a residual vibration in the piezoelectric element PZ to be detected. The process in step S140 is the same as or similar to the process in step S120. For example, the waveform determining section 40 causes the detection circuit 19 to detect the residual vibration from the piezoelectric element PZ to be detected. Accordingly, the residual vibration of the vibration plate 14 after the only one piezoelectric element PZ is driven with the i-th evaluation waveform WEi is detected by the detection circuit 19. Then, the residual vibration detected by the detection circuit 19 is analyzed by the analyzer 3. The waveform determining section 40 acquires, from the analyzer 3, residual vibration information Vinf indicating an analysis result of the residual vibration detected by the detection circuit 19. For example, the analysis result indicated by the residual vibration information Vinf includes the amplitude λM of the residual vibration detected when the only one piezoelectric element PZ is driven with the i-th evaluation waveform WEi. When the i-th evaluation waveform WEi corresponds to the “first evaluation waveform”, the residual vibration detected in step S140 is an example of the “first reference residual vibration”. When the i-th evaluation waveform WEi corresponds to the “second evaluation waveform”, the residual vibration detected in step S140 is an example of the “second reference residual vibration”.

Next, in step S150, the waveform determining section 40 determines whether or not the variable i is a final value. The final value of the variable i is, for example, a natural number greater than or equal to 2, and is the number of evaluation waveforms WE prepared in advance. That is, the waveform determining section 40 determines whether or not detection of a residual signal when the N piezoelectric elements are driven and detection of a residual signal when the M piezoelectric elements are driven have been performed on all of the evaluation waveforms WE prepared in advance.

If the result of the determination in step S150 is negative, the waveform determining section 40 adds “1” to the variable i in step S152, and then returns the process to step S110. On the other hand, if the result of the determination in step S150 is affirmative, the waveform determining section 40 causes the process to proceed to step S200.

In step S200, the waveform determining section 40 executes a waveform determination process of determining the waveform of the drive signal COM. For example, the waveform determining section 40 compares an amplitude λN of a residual vibration detected in step S120 with an amplitude λM of a residual vibration detected in step S140 for each of the evaluation waveforms WE, and determines the waveform of the drive signal COM based on results of the comparison. The waveform of the drive signal COM is determined by the execution of the process in step S200, and the operation illustrated in FIG. 8 ends.

Next, the waveform determination process executed in step S200 will be described with reference to FIG. 9.

FIG. 9 is a flowchart illustrating an example of the waveform determination process illustrated in FIG. 8. A series of processes from step S210 to step S260 illustrated in FIG. 9 corresponds to the process in step S200 illustrated in FIG. 8. The control unit 4 functions as the waveform determining section 40 in each of the steps from step S210 to step S260 illustrated in FIG. 9. The process in step S210 is executed when the result of the determination in step S150 illustrated in FIG. 8 is affirmative.

In the operation illustrated in FIG. 9, the amplitudes λNi and λMi identified by the series of processes from step S100 to step S152 illustrated in FIG. 8, a threshold TH1 that is a positive value, and a threshold TH2 that is a negative value are used. The amplitude λNi indicates the amplitude λN of the residual vibration caused by the driving of the N elements by the i-th evaluation waveform WEi, and is identified by the process in step S120 illustrated in FIG. 8. In addition, the amplitude λMi indicates the amplitude λM of the residual vibration caused by the driving of the M elements by the i-th evaluation waveform WEi, and is identified by the process in step S140 illustrated in FIG. 8. The thresholds TH1 and TH2 are determined in advance based on, for example, data obtained by a simulation, an experiment, or the like. The threshold TH1 is an example of a “first threshold”, and the threshold TH2 is an example of a “second threshold”.

First, in step S210, the waveform determining section 40 sets the variable i to “1”. After executing the process in step S210, the waveform determining section 40 causes the process to proceed to step S220.

In step S220, the waveform determining section 40 determines whether or not the amplitude difference DλNi obtained by subtracting the amplitude λMi from the amplitude λNi is less than the threshold TH1. In this way, the amplitude difference DλNi is used as an evaluation value for the i-th evaluation waveform WEi.

If the result of the determination in step S220 is negative, the waveform determining section 40 determines in step S242 that overshoot occurs, and then causes the process to proceed to step S250. That is, when the amplitude difference DλNi is equal to or greater than the threshold TH1, the waveform determining section 40 determines that the i-th evaluation waveform WEi is an evaluation waveform WE that causes overshoot, which is one type of electrical crosstalk.

As described above, when overshoot occurs, the amplitude λNi at the time of driving the N piezoelectric elements is greater than the amplitude λMi at the time of driving the M piezoelectric elements, and thus the amplitude difference DλNi is a positive value. If the amplitude difference DλNi is a positive value and exceeds the threshold TH1 that is a positive value, it is determined that noticeable overshoot occurs and may cause a problem.

On the other hand, if the result of the determination in step S220 is affirmative, the waveform determining section 40 causes the process to proceed to step S230.

In step S230, the waveform determining section 40 determines whether or not the amplitude difference DλNi obtained by subtracting the amplitude λMi from the amplitude λNi is greater than the threshold TH2. As described above, the threshold TH2 is a negative value. Therefore, for example, when the amplitude difference DλNi is a negative value and the absolute value of the amplitude difference DλNi is less than the absolute value of the threshold TH2, the waveform determining section 40 determines that the amplitude difference DλNi is greater than the threshold TH2.

If the result of the determination in step S230 is negative, the waveform determining section 40 determines in step S244 that dullness occurs, and then causes the process to proceed to step S250. That is, when the amplitude difference DλNi is equal to or less than the threshold TH2, the waveform determining section 40 determines that the i-th evaluation waveform WEi is an evaluation waveform WE that causes dullness, which is one type of electrical crosstalk.

When dullness occurs as described above, the amplitude difference DλNi is a negative value because the amplitude λNi at the time of driving the N piezoelectric elements is less than the amplitude λMi at the time of driving the M piezoelectric elements. If the amplitude difference DλNi is a negative value and is lower than the threshold TH2 which is a negative value, it is determined that noticeable dullness occurs and may cause a problem.

On the other hand, if the result of the determination in step S230 is affirmative, the waveform determining section 40 causes the process to proceed to step S240.

In step S240, the waveform determining section 40 determines that no electrical crosstalk occurs. As described above, the waveform determining section 40 evaluates whether or not electrical crosstalk occurs in the i-th evaluation waveform WEi, based on the amplitude λNi of the residual vibration caused by the driving of the N elements by the i-th evaluation waveform WEi and the amplitude λMi of the residual vibration caused by the driving of the M elements by the i-th evaluation waveform WEi. Note that the determination in steps S220 and S230 is preferably determination as to “whether or not the amplitude λNi and the amplitude λMi are values close to each other to some extent”. In this way, electrical crosstalk is evaluated by the series of processes from step S220 to step S244. In the operation illustrated in FIG. 9, the occurrence of electrical crosstalk can be determined by distinguishing between the occurrence of overshoot and the occurrence of dullness, and thus electrical crosstalk can be easily analyzed.

Hereinafter, an evaluation waveform WE determined to have no electrical crosstalk in step S240 may be referred to as an evaluation waveform WE without electrical crosstalk. A rate DE of change in an electrical potential of a waveform element Pw of the evaluation waveform WE without electrical crosstalk is, for example, a candidate for the rate of change in the electrical potential of the waveform of the drive signal COM. Therefore, the series of processes in steps S220, S230, and S240 is also regarded as a process of determining whether or not a waveform in which an electrical potential changes at a rate DE of change in an electrical potential of a waveform element Pw of the i-th evaluation waveform WEi is a candidate for the waveform of the drive signal COM. For example, when the amplitude difference DλNi is less than the threshold TH1 which is a positive value, and is greater than the threshold TH2 which is a negative value, the waveform determining section 40 determines that the waveform in which the electrical potential changes at the rate DE of change in the electrical potential of the waveform element Pw of the i-th evaluation waveform WEi is a candidate for the waveform of the drive signal COM. After executing the processing in step S240, the waveform determining section 40 causes the process to proceed to step S250.

In step S250, the waveform determining section 40 determines whether or not the variable i is the final value. That is, the waveform determining section 40 determines whether or not the evaluation of electrical crosstalk based on the residual vibrations detected by the series of processes from step S100 to step S152 illustrated in FIG. 8 has been ended.

If the result of the determination in step S250 is negative, the waveform determining section 40 adds “1” to the variable i in step S252, and then returns the process to step S220. On the other hand, if the result of the determination in step S250 is affirmative, the process proceeds to step S260.

In step S260, the waveform determining section 40 determines the waveform of the drive signal COM based on the evaluation waveform WE without electrical crosstalk. The determination of the waveform of the drive signal COM includes, for example, the determination of the rate of change in the electrical potential of the waveform element Pa3 of the drive signal COM.

For example, when one evaluation waveform WE without electrical crosstalk is present, the waveform determining section 40 sets the rate of change in the electrical potential of the waveform element Pa3 of the drive signal COM to a rate DE of change in an electrical potential of a waveform element Pw of the evaluation waveform WE without electrical crosstalk.

In addition, for example, when a plurality of evaluation waveforms WE without electrical crosstalk are present, the waveform determining section 40 sets one of rates DE of change in electrical potentials of waveform elements Pw of the plurality of evaluation waveforms WE as the rate of change in the electrical potential of the waveform element Pa3 of the drive signal COM. The presence of the plurality of evaluation waveforms WE without electrical crosstalk corresponds to the presence of a plurality of candidates for the waveform of the drive signal COM. An example of a method of determining the rate of change in the electrical potential of the waveform element Pa3 of the drive signal COM when a plurality of candidates for the waveform of the drive signal COM are present will be described below.

Hereinafter, an evaluation waveform WE corresponding to an amplitude difference DλN indicates an evaluation waveform WE for which the amplitude difference DλN is used as an evaluation value, and the amplitude difference DλN corresponding to the evaluation waveform WE indicates the amplitude difference DλN used as the evaluation value for the evaluation waveform WE. In addition, hereinafter, an amplitude difference DλN used when a candidate for the waveform of the drive signal COM is determined indicates an amplitude difference DλN corresponding to an evaluation waveform WE without electrical crosstalk.

For example, when a plurality of candidates for the waveform of the drive signal COM are present, the waveform determining section 40 may set, as the waveform of the drive signal COM, a candidate that causes a minimum amplitude difference DλN obtained by subtracting the amplitude λM of the reference residual vibration from an amplitude λN of a residual vibration among the plurality of candidates. In this case, a rate DE of change in an electrical potential in the candidate that causes the minimum amplitude difference DλN among the plurality of candidates is the rate of change in the electrical potential of the waveform element Pa3 of the drive signal COM. Specifically, the waveform determining section 40 may set, as the rate of change in the electrical potential of the waveform element Pa3 of the drive signal COM, a rate DE of change in an electrical potential of a waveform element Pw of an evaluation waveform WE corresponding to the amplitude difference DλN having the minimum absolute value among the plurality of amplitude differences DλN used to determine the plurality of candidates for the waveform of the drive signal COM. For example, the waveform determining section 40 may set the rate of change in the electrical potential of the waveform element Pa3 of the drive signal COM as the rate DE1 of change in the electrical potential when the amplitude difference DλN having the minimum absolute value among the amplitude differences DλN used to determine the plurality of candidates for the waveform of the drive signal COM is the amplitude difference DλN of the evaluation waveform WE1. In this aspect, it can be expected that the vibration of the vibration plate 14 that occurs when the N piezoelectric elements are driven and the vibration of the vibration plate 14 that occurs when the M piezoelectric elements are driven are similar to each other. Therefore, in this aspect, it is possible to suppress an increase in a difference between the characteristics of ejection of the ink when the N piezoelectric elements are driven and the characteristics of ejection of ink when the M piezoelectric elements are driven.

In addition, for example, when a plurality of candidates for the waveform of the drive signal COM are present, the waveform determining section 40 may set, as the waveform of the drive signal COM, a candidate in which an electrical potential changes at the highest rate DE among the plurality of candidates. In this case, the rate DE of change in the electrical potential in the candidate in which the rate DE of change in the electrical potential the highest among the plurality of candidates is the rate of change in the electrical potential of the waveform element Pa3 of the drive signal COM. Specifically, the waveform determining section 40 may identify the candidate in which the rate DE of change in the electrical potential is the highest among the plurality of candidates for the waveform of the drive signal COM, and may set the rate DE of change in the electrical potential of the identified candidate as the rate of change in the electrical potential of the waveform element Pa3 of the drive signal COM. For example, when the candidate in which the rate DE of change in the electrical potential is the highest among the plurality of candidates for the waveform of the drive signal COM is a waveform in which the electrical potential changes at the rate DE1, the waveform determining section 40 may set the rate of change in the electrical potential of the waveform element Pa3 of the drive signal COM as the rate DE1. In this aspect, since it is possible to increase the rate of change in the electrical potential of the waveform element Pa3 of the drive signal COM in a range in which overshoot does not occur, it is possible to cause the vibration plate 14 to largely vibrate in a range in which overshoot does not occur. Therefore, in this aspect, it is possible to efficiently eject a large ink droplet within a desired range.

Note that the method of determining the rate of change in the electrical potential of the waveform element Pa3 of the drive signal COM when a plurality of candidates for the waveform of the drive signal COM are present is not limited to the above-described example. For example, the waveform determining section 40 may set an average of a plurality of rates of change in electrical potentials that correspond to a plurality of candidates for the waveform of the drive signal COM as the rate of change in the electrical potential of the waveform element Pa3 of the drive signal COM. Alternatively, the waveform determining section 40 may present, to the user, candidate information indicating a candidate for the waveform of the drive signal COM, and may determine the rate of change in the electrical potential of the waveform element Pa3 of the drive signal COM based on an input by the user for the candidate information. For example, the waveform determining section 40 may present, to the user, information serving as candidate information and indicating a plurality of waveform candidates in which a plurality of rates of change in electrical potentials are set as the rate of change in the electrical potential of the waveform element Pa3. Then, the waveform determining section 40 may allow the user to select a waveform to be used as the waveform of the drive signal COM from among the plurality of waveform candidates indicated by the candidate information, and may determine the waveform candidate selected by the user as the waveform of the drive signal COM.

In this way, in the present embodiment, by determining the waveform of the drive signal COM based on a result of evaluating electrical crosstalk, it is possible to easily suppress the occurrence of electrical crosstalk. That is, in the present embodiment, it is possible to appropriately and easily determine the waveform of the drive signal COM that suppresses the occurrence of electrical crosstalk under the usage condition of the liquid ejecting apparatus 100. The operation illustrated in FIGS. 8 and 9 ends when the process in step S260 ends.

Note that the operation of the liquid ejecting apparatus 100 for determination of the waveform of the drive signal COM is not limited to the example illustrated in FIGS. 8 and 9. For example, the series of processes in steps S130 and S140 illustrated in FIG. 8 may be executed before the series of processes in steps S110 and S120. Further, for example, the process in step S230 illustrated in FIG. 9 may be executed before the process in step S220. Alternatively, the process in step S230 may be executed together with the process in step S220. For example, the waveform determining section 40 may determine whether or not the amplitude difference DλNi obtained by subtracting the amplitude λMi from the amplitude λNi is less than the threshold TH1 and greater than the threshold TH2. In this case, if the result of the determination in step S220 including the result of the determination in step S230 is negative, the waveform determining section 40 may determine that electrical crosstalk occurs without particularly distinguishing between overshoot and the dullness.

Further, for example, as an evaluation value for each evaluation waveform WEi, that is, as the amplitude difference DλNi, a value obtained by subtracting a reference value common to the plurality of evaluation waveforms WE from the amplitude λNi may be used. In this case, the common reference value may be stored in advance in a storage unit or the like (not illustrated) of the liquid ejecting head 1. Alternatively, the common reference value may be transmitted from the head manufacturer via a network (not illustrated) and stored in the storage unit 5 or the like after shipment of the liquid ejecting head 1. The common reference value is an example of a “first reference value”. Further, when the evaluation waveform WEi corresponds to the “first evaluation waveform”, the amplitude difference DλNi obtained by subtracting the common reference value from the amplitude λNi is an example of the “first amplitude difference” as the evaluation value for the evaluation waveform WEi. In this case, the determination of whether or not the amplitude difference DλNi calculated using the common reference value is less than the threshold TH1 and greater than the threshold TH2 can also be regarded as determination of whether or not the amplitude λNi is within a predetermined range. The lower limit of the predetermined range is a value obtained by adding the common reference value to the threshold TH2, and the upper limit of the predetermined range is a value obtained by adding the common reference value to the threshold TH1. Further, when the common reference value is used for a plurality of evaluation waveforms WE, the series of processes in steps S130 and S140 illustrated in FIG. 8 may be omitted. In this case, it is possible to simplify the operation of the liquid ejecting apparatus 100 for determination of the waveform of the drive signal COM.

Further, for example, in FIG. 8, it is assumed that the value N is equal to the value K, but the value N may be a natural number greater than or equal to 2 and less than the value K. However, the value N is preferably set such that an amplitude difference DλN used as an evaluation value for an evaluation waveform WE in which a rate DE of change in an electrical potential is the highest or lowest among the plurality of evaluation waveforms WE is a certain magnitude. In addition, the N piezoelectric elements PZ driven in the driving of the N elements may not be adjacent to each other. That is, the N nozzles Nz corresponding to the N piezoelectric elements PZ may not be adjacent to each other. For example, the N nozzles Nz may be arranged at every other nozzle or N nozzles Nz arranged at every third nozzle. In this aspect, it is possible to suppress an effect of structural crosstalk which occurs due to the structure of the liquid ejecting head 1, such as the arrangement of the nozzles NZ, on a residual vibration which is detected in order to evaluate electrical crosstalk. That is, in this aspect, it is possible to accurately detect a residual vibration for evaluating electrical crosstalk. As a result, in this aspect, the electrical crosstalk can be accurately evaluated. Therefore, in this aspect, it is possible to appropriately determine the rate of change in the electrical potential of the waveform element Pa3 of the drive signal COM based on a result of evaluating electrical crosstalk.

Further, for example, in FIG. 8, it is assumed that the value M is “1”, but the value M may be a natural number greater than or equal to 2 and less than the value N. However, the value M is preferably set so that overshoot does not occur even when the M piezoelectric elements PZ are driven with each of the plurality of evaluation waveforms WE.

Further, for example, when a large ink droplet within a desired range is to be ejected without causing overshoot, the waveform determining section 40 may determine the amplitude differences DλN in descending order of the rate DE of change in the electrical potential among the plurality of evaluation waveforms WE. Then, the waveform determining section 40 may cause the process to proceed to step S260 when the waveform determining section 40 identifies an amplitude difference DλNi that is less than the threshold TH1 and greater than the threshold TH2. In this aspect, it is possible to efficiently determine the rate of change in the electrical potential of the waveform element Pa3 of the drive signal COM.

As described above, in the present embodiment, the liquid ejecting apparatus 100 includes the liquid ejecting head 1 including the plurality of nozzles NZ from which ink is ejected, the plurality of piezoelectric elements PZ that are provided corresponding to the plurality of nozzles NZ and are driven by the drive signal COM supplied to the plurality of piezoelectric elements PZ, the vibration plate 14 that vibrates by driving of at least one of the plurality of piezoelectric elements PZ, and the detection circuit 19 that detects a residual vibration of the vibration plate 14 after the at least one of the plurality of piezoelectric elements PZ is driven, and the waveform determining section 40. The waveform determining section 40 causes the detection circuit 19 to detect, as the first residual vibration, a residual vibration of the vibration plate 14 after N piezoelectric elements PZ corresponding to N nozzles NZ among the plurality of nozzles NZ are driven with the evaluation waveform WE1 in which the rate of change in the electrical potential that is the amount of change in the electrical potential per unit time is the rate DE1, causes the detection circuit 19 to detect, as the second residual vibration, a residual vibration of the vibration plate 14 after the N piezoelectric elements PZ are driven with the evaluation waveform WE2 in which the rate of change in the electrical potential is the rate DE2 lower than the rate DE1, and determines the waveform of the drive signal COM based on the first residual vibration and the second residual vibration.

As described above, in the present embodiment, the waveform of the drive signal COM is determined based on the first residual vibration after the N piezoelectric elements PZ are driven with the evaluation waveform WE1 in which the rate of change in the electrical potential is the rate DE1 and the second residual vibration after the N piezoelectric elements PZ are driven with the evaluation waveform WE2 in which the rate of change in the electrical potential is the rate DE2. The rate of change in the electrical potential of the waveform of the drive signal COM affects the occurrence of electrical crosstalk. Further, the occurrence of electrical crosstalk affects the residual vibrations after the N piezoelectric elements PZ are driven. Therefore, in the present embodiment, the rate of change in the electrical potential of the waveform of the drive signal COM can be determined to be an electrical potential change rate which suppresses the occurrence of electrical crosstalk, based on the first residual vibration and the second residual vibration. That is, in the present embodiment, it is possible to appropriately and easily determine the waveform of the drive signal COM that suppresses the occurrence of electrical crosstalk under the usage condition of the liquid ejecting apparatus 100.

In addition, in the present embodiment, the waveform determining section 40 may cause the detection circuit 19 to detect, as the third residual vibration, a residual vibration of the vibration plate 14 after the N piezoelectric elements PZ are driven with the evaluation waveform WE3 in which the rate of change in the electrical potential is the rate DE3 lower than the rate DE2, and may determine the waveform of the drive signal COM based on the first residual vibration, the second residual vibration, and the third residual vibration. In this aspect, since the occurrence of electrical crosstalk is evaluated while the electrical potentials change at the various rates DE, the rate of change in the electrical potential of the waveform of the drive signal COM can be easily determined to be an electrical potential change rate which suppresses the occurrence of electrical crosstalk.

In addition, in the present embodiment, the waveform determining section 40 may cause the detection circuit 19 to detect, as the first reference residual vibration, the reference residual vibration of the vibration plate 14 after only M (M is a positive integer less than N) piezoelectric elements PZ among the N piezoelectric elements PZ are driven with the evaluation waveform WE1, and determine the waveform of the drive signal COM based on the first residual vibration, the second residual vibration, and the first reference residual vibration. In this aspect, the first reference residual vibration after the M piezoelectric elements PZ are driven is also used to determine the waveform of the drive signal COM. In this case, M is less than N. Therefore, in this aspect, it is possible to accurately evaluate the occurrence of electrical crosstalk. As a result, in this aspect, the rate of change in the electrical potential of the waveform of the drive signal COM can be accurately determined to be an electrical potential change rate which suppresses the occurrence of electrical crosstalk.

In the present embodiment, the N nozzles Nz may not be adjacent to each other. Accordingly, in this aspect, it is possible to suppress an effect of structural crosstalk which occurs due to the structure of the liquid ejecting head 1, such as the arrangement of the nozzles NZ, on a residual vibration which is detected in order to evaluate electrical crosstalk. That is, in this aspect, it is possible to accurately detect a residual vibration for evaluating electrical crosstalk. As a result, in this aspect, the electrical crosstalk can be accurately evaluated. As a result, in this aspect, the rate of change in the electrical potential of the waveform of the drive signal COM can be accurately determined to be an electrical potential change rate which suppresses the occurrence of electrical crosstalk.

In addition, in the present embodiment, when the amplitude difference DλN1 obtained by subtracting the amplitude λM1 of the first reference residual vibration from the amplitude λN1 of the first residual vibration is less than the threshold TH1 which is a positive value, and is greater than the threshold TH2 which is a negative value, the waveform determining section 40 may set, as a candidate for the waveform of the drive signal COM, a waveform in which an electrical potential changes at the rate DE1. In this manner, in this aspect, the waveform determining section 40 sets, as a candidate for the waveform of the drive signal COM, a waveform in which an electrical potential changes at a rate DE of change in an electrical potential of an evaluation waveform WE that causes a small amplitude difference DλN corresponding to the amount of change in an amplitude of a residual vibration when the number of piezoelectric elements PZ driven is changed. Accordingly, in this aspect, it is possible to appropriately set, as a candidate for the waveform of the drive signal COM, a waveform in which an electrical potential changes at a rate DE which suppresses the occurrence of electrical crosstalk. As a result, in this aspect, the rate of change in the electrical potential of the waveform of the drive signal COM can be appropriately determined to be an electrical potential change rate which suppresses the occurrence of electrical crosstalk.

In the present embodiment, when the amplitude difference DλN1 is greater than the threshold TH1 or less than the threshold TH2, the waveform determining section 40 may not set, as a candidate for the waveform of the drive signal COM, a waveform in which an electrical potential changes at the DE1. In this manner, in this aspect, the waveform determining section 40 does not set, as a candidate for the waveform of the drive signal COM, a waveform in which an electrical potential changes at a rate DE of change in an electrical potential of an evaluation waveform WE that causes a large amplitude difference DλN corresponding to the amount of change in an amplitude of a residual vibration when the number of piezoelectric elements PZ driven is changed. Accordingly, in this aspect, it is possible to suppress setting of a waveform in which an electrical potential changes at a rate DE that causes the occurrence of electrical crosstalk as a candidate for the waveform of the drive signal COM. As a result, in this aspect, determining that the rate of change in the electrical potential of the waveform of the drive signal COM is the rate DE of change in the electrical potential that causes the occurrence of electrical crosstalk can be suppressed.

Further, in the present embodiment, when the amplitude difference DλN1 obtained by subtracting the common reference value stored in advance from the amplitude λN1 of the first residual vibration is less than the threshold TH1 which is a positive value, and is greater than the threshold TH2 which is a negative value, the waveform determining section 40 may set, as a candidate for the waveform of the drive signal COM, a waveform in which an electrical potential changes at the rate DE1. In this manner, in this aspect, the waveform determining section 40 sets, as a candidate for the waveform of the drive signal COM, a waveform in which an electrical potential changes at a rate DE of change in an electrical potential of an evaluation waveform WE that causes a small amplitude difference DλN corresponding to the difference between an amplitude of a residual vibration when the number of piezoelectric elements PZ driven is large and the reference value. Accordingly, in this aspect, it is possible to set, as a candidate for the waveform of the drive signal COM, a waveform in which an electrical potential changes at a rate DE which suppresses the occurrence of electrical crosstalk, without detecting a residual vibration when the number of piezoelectric elements PZ driven is small. As a result, in this aspect, the rate of change in the electrical potential of the waveform of the drive signal COM can be easily determined to be an electrical potential change rate which suppresses the occurrence of electrical crosstalk.

In addition, in the present embodiment, when a plurality of candidates for the waveform of the drive signal COM are present, the waveform determining section 40 may set, as the waveform of the drive signal COM, a candidate that causes a minimum amplitude difference DλN obtained by subtracting the amplitude λM of the reference residual vibration from the amplitude λN of the residual vibration among the candidates. As described above, in this aspect, the waveform determining section 40 sets, as the rate of change in the electrical potential of the waveform of the drive signal COM, a rate DE of change in an electrical potential that causes a minimum amplitude difference DλN corresponding to the amount of change in an amplitude of a residual vibration when the number of piezoelectric elements PZ driven is changed among the plurality of rates DE of change in the electrical potentials that suppress the occurrence of electrical crosstalk. Therefore, in this aspect, it is possible to suppress a variation in the characteristics of ejection of ink depending on the number of piezoelectric elements PZ driven.

In addition, in the present embodiment, when a plurality of candidates for the waveform of the drive signal COM are present, the waveform determining section 40 may set, as the waveform of the drive signal COM, a candidate in which an electrical potential changes at the highest rate DE among the candidates. As described above, in this aspect, the waveform determining section 40 sets, as the rate of change in the electrical potential of the waveform of the drive signal COM, the highest rate DE of change in the electrical potential among the plurality of rates DE of change in the electrical potentials that suppress the occurrence of electrical crosstalk. Therefore, in this aspect, it is possible to generate a large vibration in the vibration plate 14 within a range in which electrical crosstalk does not occur. As a result, in this aspect, it is possible to efficiently eject a large ink droplet within a desired range.

In addition, in the present embodiment, the waveform determining section 40 may present, to the user, candidate information indicating a candidate for the waveform of the drive signal COM, and may determine the rate of change in the electrical potential of the waveform of the drive signal COM based on an input by the user for the candidate information. As described above, in this aspect, the waveform determining section 40 determines the rate of change in the electrical potential of the waveform of the drive signal COM based on the input by the user for the plurality of rates DE of change in the electrical potentials that suppress the occurrence of electrical crosstalk. Accordingly, for example, in this aspect, the waveform determining section 40 may set, as the rate of change in the electrical potential of the waveform of the drive signal COM, the rate DE of change in the electrical potential selected by the user from among the plurality of rates DE of change in the electrical potentials that suppress the occurrence of electrical crosstalk. As described above, in this aspect, it is possible to allow the user to select the rate of change in the electrical potential of the waveform of the drive signal COM from among the plurality of rates DE of change in the electrical potentials that suppress the occurrence of electrical crosstalk.

In the present embodiment, the evaluation waveform WE1 may include a waveform element Pw in which the electrical potential changes at the rate DE1, and the evaluation waveform WE2 may include a waveform element Pw in which the electrical potential changes at the rate DE2. A difference between electrical potentials of the waveform element Pw of the evaluation waveform WE1 in a period of time from a start point to an end point of the waveform element Pw of the evaluation waveform WE may be equal to a difference between electrical potentials of the waveform element Pw of the evaluation waveform WE2 in a period of time from a start point to an end point of the waveform element Pw of the evaluation waveform WE2, and the period of time from the start point to the end point of the waveform element Pw of the evaluation waveform WE1 may be shorter than the period of time from the start point to the end point of the waveform element Pw of the evaluation waveform WE2. As described above, in this aspect, by adjusting a period of time from a start point to an end point of a waveform element Pw, the rate DE of change in the electrical potential of the waveform element Pw can be adjusted.

In the present embodiment, the evaluation waveform WE1 may include a waveform element Pw in which the electrical potential changes at the rate DE1, and the evaluation waveform WE2 may include a waveform element Pw in which the electrical potential changes at the rate DE2. The difference between the electrical potentials of the waveform element Pw of the evaluation waveform WE1 in the period of time from the start point to the end point of the waveform element Pw of the evaluation waveform WE1 may be greater than the difference between the electrical potentials of the waveform element Pw of the evaluation waveform WE2 in the period of time from the start point to the end point of the waveform element Pw of the evaluation waveform WE2, and the period of time from the start point to the end point of the waveform element Pw of the evaluation waveform WE1 may be equal to the period of time from the start point to the end point of the waveform element Pw of the evaluation waveform WE2. In this manner, in this aspect, by adjusting a difference between electrical potentials from a start point to an end point of a waveform element Pw, the rate DE of change in the electrical potential of the waveform element Pw can be adjusted.

In addition, in the present embodiment, each of the evaluation waveform WE1 and the evaluation waveform WE2 may include a first expansion element which is a waveform element which expands the pressure chambers communicating with the respective nozzles NZ, and a contraction element which is a waveform element after the first expansion element and contracts the pressure chambers. The rate DE1 of change in the electrical potential and the rate DE2 of change in the electrical potential may be rates of change in the electrical potentials of the contraction elements. As described above, in this aspect, the pull-push waveforms are used as the evaluation waveforms WE, and rates DE of change in electrical potentials of waveform elements Pw corresponding to the push of the pull-push waveforms are adjusted. Therefore, in this aspect, in particular, when a pull-push waveform is used as the waveform of the drive signal COM, it is possible to accurately evaluate the occurrence of electrical crosstalk.

In addition, in the present embodiment, each of the evaluation waveform WE1 and the evaluation waveform WE2 may include a first expansion element which is a waveform element which expands the pressure chambers communicating with the respective nozzles NZ, a contraction element which is a waveform element after the first expansion element and contracts the pressure chambers, and a second expansion element which is a waveform element after the contraction element and expands the pressure chambers. The rate DE1 of change in the electrical potential and the rate DE2 of change in the electrical potential may be rates of change in the electrical potentials of the contraction elements. As described above, in this aspect, the pull-push-pull waveforms are used as the evaluation waveforms WE, and the rates DE of change in the electrical potentials of the waveform elements Pw corresponding to the push of the pull-push-pull waveforms are adjusted. Therefore, in this aspect, in particular, when a pull-push-pull waveform is used as the waveform of the drive signal COM, it is possible to accurately evaluate the occurrence of electrical crosstalk.

### First Modification Example

In the above-described embodiment, the case where the waveform of the drive signal COM is determined based on the amplitude λN of the residual vibration detected when the N piezoelectric elements are driven and the amplitude λM of the residual vibration detected when the M piezoelectric elements are driven has been exemplified, but the present disclosure is not limited to such an aspect. For example, the waveform determining section 40 may cause the detection circuit 19 to detect, as a fourth residual vibration, a residual vibration of the vibration plate 14 after only L (L is a positive integer greater than M and less than N) piezoelectric elements PZ among the N piezoelectric elements PZ are driven with the evaluation waveform WE1. Then, the waveform determining section 40 may determine the waveform of the drive signal COM based on the first residual vibration, the second residual vibration, the fourth residual vibration, and the first reference residual vibration. In the present modification example, the value K is a natural number greater than or equal to 3. In the present modification example, the value N is a positive integer satisfying “3≤N≤K”, and the value M and the value L are positive integers satisfying “1≤M<L<N”. For example, the L piezoelectric elements PZ may be arranged every other element or may be arranged every third element. Further, the N piezoelectric elements PZ may be all of the K piezoelectric elements PZ. In addition, the M piezoelectric elements PZ may be one piezoelectric element PZ. The examples of the N piezoelectric elements PZ, the M piezoelectric elements PZ, and the L piezoelectric elements PZ are not limited to the above-described examples. For example, the N piezoelectric elements PZ may be arranged every other element, and the L piezoelectric elements PZ may be arranged every third element.

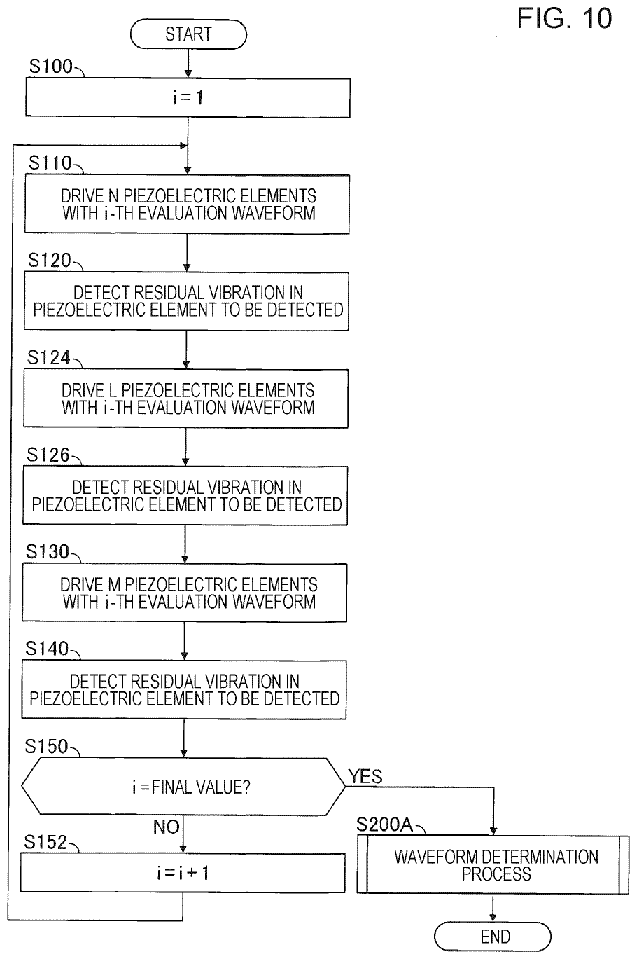

Next, an operation of the liquid ejecting apparatus 100 according to the first modification example will be described with reference to FIG. 10. Hereinafter, the driving of only the L piezoelectric elements PZ among the K piezoelectric elements PZ may be referred to as driving of the L elements. In addition, hereinafter, an amplitude of a residual vibration detected when the L piezoelectric elements are driven is referred to as an amplitude λL.

FIG. 10 is a flowchart illustrating an example of the operation of the liquid ejecting apparatus 100 according to the second modification example. The operation illustrated in FIG. 10 is the operation of the liquid ejecting apparatus 100 for determination of the waveform of the drive signal COM. Note that the operation illustrated in FIG. 10 is the same as the operation illustrated in FIG. 9 except that a series of processes in steps S124 and S126 is executed and a process in step S200A is executed instead of the process in step S200 illustrated in FIG. 9. The series of processes in steps S124 and S126 will be mainly described with reference to FIG. 10. For example, the series of processes in steps S124 and S126 is executed after the series of processes in steps S110 and S120 is executed.

In step S124, the waveform determining section 40 controls the liquid ejecting head 1 so as to drive the L piezoelectric elements with the i-th evaluation waveform WEi. For example, the waveform determining section 40 selects the signal of the i-th evaluation waveform WEi as the drive signal COM, and controls the liquid ejecting head 1 such that only the L piezoelectric elements PZ among the K piezoelectric elements PZ are driven using the selected drive signal COM.

Next, in step S126, the waveform determining section 40 detects a residual vibration in a piezoelectric element PZ to be detected. The process in step S126 is the same as or similar to the process in step S120. For example, the waveform determining section 40 causes the detection circuit 19 to detect the residual vibration from the piezoelectric element PZ to be detected. Accordingly, the residual vibration of the vibration plate 14 after only the L piezoelectric elements PZ are driven with the i-th evaluation waveform WEi is detected by the detection circuit 19. Then, the residual vibration detected by the detection circuit 19 is analyzed by the analyzer 3. The waveform determining section 40 acquires, from the analyzer 3, residual vibration information Vinf indicating an analysis result of the residual vibration detected by the detection circuit 19. For example, the analysis result indicated by the residual vibration information Vinf includes an amplitude λLi of the residual vibration detected when only the L piezoelectric elements PZ are driven with the i-th evaluation waveform WEi. When the i-th evaluation waveform WEi corresponds to the “first evaluation waveform”, the residual vibration detected in step S126 is an example of the “fourth residual vibration”. When the i-th evaluation waveform WEi corresponds to the “second evaluation waveform”, the residual vibration detected in step S126 is an example of a “fifth residual vibration”.

After the series of processes in steps S124 and S126 is executed, the series of processes in steps S130 and S140 is executed. However, the order in which the series of processes in steps S110 and S120, the series of processes in steps S124 and S126, and the series of processes in steps S130 and S140 are executed is not limited to the example illustrated in FIG. 10. For example, the series of processes in steps S124 and S126 may be executed before the series of processes in steps S110 and S120, or may be executed after the series of processes in steps S130 and S140.

The process in step S200A is executed when the result of the determination in step S150 is affirmative.

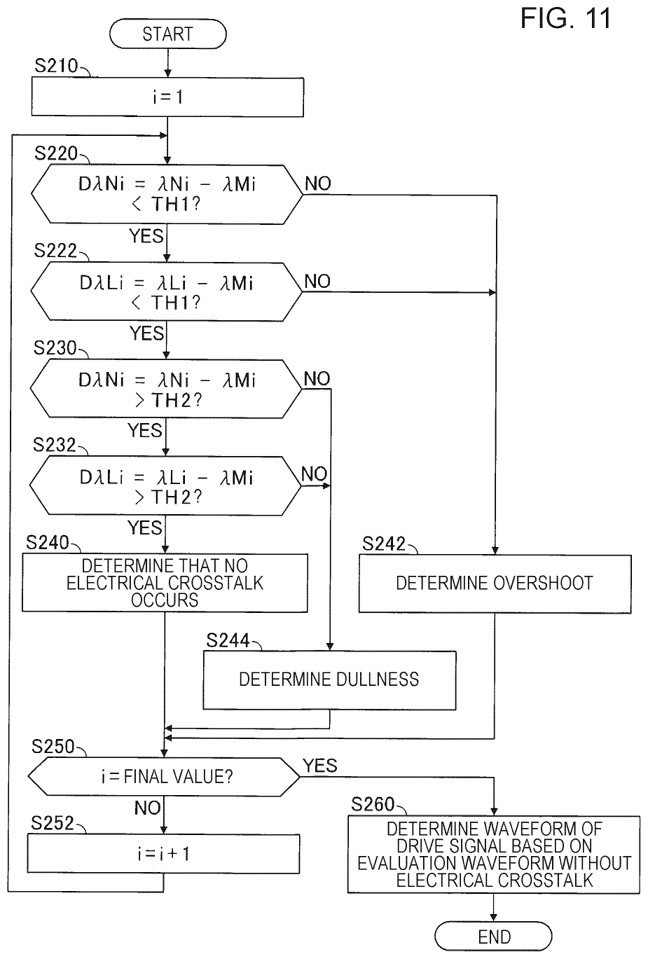

Next, the waveform determination process executed in step S200A will be described with reference to FIG. 11.

FIG. 11 is a flowchart illustrating an example of the waveform determination process illustrated in FIG. 10. A series of processes from step S210 to step S260 illustrated in FIG. 11 corresponds to the process in step S200A illustrated in FIG. 10. The control unit 4 functions as the waveform determining section 40 in each step from step S210 to step S260 illustrated in FIG. 11. The process in step S210 is executed when the result of the determination in step S150 illustrated in FIG. 10 is affirmative.

The operation illustrated in FIG. 11 is the same as the operation illustrated in FIG. 9 except that a process in step S222 and a process in step S232 are executed. The process in step S222 and the process in step S232 will be mainly described with reference to FIG. 11. For example, the process in step S222 is executed when the result of the determination in step S220 is affirmative.

In step S222, the waveform determining section 40 determines whether or not an amplitude difference DλLi obtained by subtracting the amplitude λMi from an amplitude λLi is less than the reference value TH1. Thus, the amplitude difference DλLi is used as an evaluation value for the i-th evaluation waveform WEi. That is, in the present modification example, the amplitude difference DλNi and the amplitude difference DλLi are used as evaluation values for the i-th evaluation waveform WEi.

If the result of the determination in step S222 is negative, the waveform determining section 40 determines in step S242 that overshoot occurs, and then causes the process to proceed to step S250. That is, when the amplitude difference DλLi is greater than or equal to the reference value TH1, the waveform determining section 40 determines that the i-th evaluation waveform WEi is the evaluation waveform WE that causes overshoot.

On the other hand, if the result of the determination in step S222 is affirmative, the waveform determining section 40 causes the process to proceed to step S230.

Further, for example, the process in step S232 is executed when the result of the determination in step S230 is affirmative.

In step S232, the waveform determining section 40 determines whether or not the amplitude difference DλLi obtained by subtracting the amplitude λMi from the amplitude λLi is greater than the threshold TH2.

If the result of the determination in step S232 is negative, the waveform determining section 40 determines in step S244 that dullness occurs, and then causes the process to proceed to step S250. In other words, when the amplitude difference DλLi is less than or equal to the threshold TH2, the waveform determining section 40 determines that the i-th evaluation waveform WEi is an evaluation waveform WE that causes dullness.

On the other hand, if the result of the determination in step S232 is affirmative, the waveform determining section 40 causes the process to proceed to step S240.

As described above, in the present modification example, the waveform determining section 40 evaluates whether or not electrical crosstalk occurs in the i-th evaluation waveform WEi by using the amplitude λNi, the amplitude λMi, and the amplitude λLi. Note that the determination in step S222 and S232 is preferably determination as to “whether or not the amplitudes λLi and λMi are values close to each other to some extent”.

As described above, also in the present modification example, by determining the waveform of the drive signal COM based on the result of evaluating electrical crosstalk, it is possible to easily suppress the occurrence of electrical crosstalk. Further, in the present modification example, in addition to the amplitude λNi of the residual vibration detected when the N piezoelectric elements are driven, the amplitude λLi of the residual vibration detected when the L piezoelectric elements are driven is also used for the evaluation of whether or not electrical crosstalk occurs in the i-th evaluation waveform WEi. Therefore, in the present modification example, even when the condition in which electrical crosstalk increases is not the driving of the N elements, for example, even when electrical crosstalk increases when the L piezoelectric elements are driven, it is possible to appropriately determine whether or not electrical crosstalk occurs.

The operation of the liquid ejecting apparatus 100 for determination of the waveform of the drive signal COM is not limited to the example illustrated in FIGS. 10 and 11. For example, the order in which the process in step S220, the process in step S222, the process in step S230, and the process in step S232 illustrated in FIG. 11 are executed may be different from the order illustrated in FIG. 11. Further, the process in step S232 may be executed together with the process in step S222. For example, the waveform determining section 40 may determine whether or not the amplitude difference DλLi obtained by subtracting the amplitude λMi from the amplitude λLi is less than the threshold TH1 and greater than the threshold TH2. In this case, if the result of the determination in step S222 including the determination in step S232 is negative, the waveform determining section 40 may determine that electrical crosstalk occurs without particularly distinguishing between overshoot and dullness.

Further, for example, as an evaluation value for each evaluation waveform WEi, the amplitude difference DλNi obtained by subtracting the reference value common to the plurality of evaluation waveforms WE from the amplitude λNi and an amplitude difference DλLi obtained by subtracting the reference value common to the plurality of evaluation waveforms WE from the amplitude λLi may be used.

In addition, for example, when a large ink droplet within a desired range is to be ejected without causing overshoot, the waveform determining section 40 may execute the series of processes from step S220 to step S250 in descending order of the rate DE of change in the electrical potential among the plurality of evaluation waveforms WE. Then, the waveform determining section 40 may cause the process to proceed to step S260 when the evaluation waveform WEi without electrical crosstalk is identified. In this aspect, it is possible to efficiently determine the rate of change in the electrical potential of the waveform element Pa3 of the drive signal COM.

As described above, also in the present modification example, the same effects as those of the embodiment described above can be obtained. Further, in the present modification example, in addition to the residual vibration detected when the N piezoelectric elements are driven, the residual vibration detected when the L piezoelectric elements are driven is used for the evaluation of whether or not electrical crosstalk occurs. Therefore, in the present modification example, it is possible to appropriately determine whether or not electrical crosstalk occurs.

### Second Modification Example

In the above-described embodiment and modification example, waveform information indicating the evaluation waveforms WE may be stored in advance in the storage unit (not illustrated) or the like of the liquid ejecting head 1 when the head manufacturer manufactures the liquid ejecting head 1. Alternatively, the waveform information indicating the evaluation waveforms WE may be stored in the storage unit 5 or the like from the head manufacturer via a network (not illustrated) after shipment of the liquid ejecting head 1. For example, when the operation illustrated in FIG. 8 is to be executed, the waveform information indicating the evaluation waveforms WE prepared by the head manufacturer is read from the storage unit 5 or the like in which the waveform information indicating the evaluation waveforms WE is stored.

As described above, also in the present modification example, the same effects as those of the embodiment described above can be obtained.

### Third Modification Example

The case where the control unit 4 performs the analysis or the like of the residual vibration detected by the detection circuit 19 is described as an example in the embodiment and modification examples described above, but the present disclosure is not limited to such an aspect. For example, the analysis or the like of the residual vibration detected by the detection circuit 19 may be performed by a control unit such as a CPU of an external server managed by the head manufacturer. In the present modification example, the liquid ejecting apparatus 100 includes a communication unit that can communicate with the external server managed by the head manufacturer. In addition, for example, the control unit 4 transmits residual vibration data indicating the residual vibration detected by the detection circuit 19 to the external server managed by the head manufacturer via the communication unit. The control unit included in the external server analyzes the residual vibration data transmitted from the liquid ejecting apparatus 100. Specifically, for example, the control unit included in the external server identifies the amplitude of the residual vibration indicated by the residual vibration data, and executes the operation illustrated in FIG. 9 or the operation illustrated in FIG. 11 using the identified amplitude or the like. The control unit included in the external server may transmit, to the liquid ejecting apparatus 100, information indicating the waveform of the drive signal COM that suppresses the occurrence of crosstalk.

As described above, also in the present modification example, the same effects as those of the embodiment described above can be obtained.

### Fourth Modification Example

In the above-described embodiment, the case where the candidate information indicating a candidate for the waveform of the drive signal COM is presented to the user as the information indicating the rate DE of change in the electrical potential of the waveform element Pw of the evaluation waveform WE without electrical crosstalk has been exemplified, but the present disclosure is not limited to such an aspect. For example, the waveform determining section 40 may present, to the user, information indicating the rates DE of change in the electrical potentials of the waveform elements Pw of all the evaluation waveforms WE used for the evaluation of electrical crosstalk so that the user can grasp whether or not each rate DE of change in the electrical potential is a rate of change in an electrical potential of a candidate for the waveform of the drive signal COM. As described above, also in the present modification example, the same effects as those of the embodiment described above can be obtained.

### Fifth Modification Example

In the embodiment and the modification examples described above, the case where the piezoelectric body Zb is deformed in the Z1 direction by changing the electrical potential of the individual drive signal Vin[k] from the low electrical potential to the high electrical potential has been exemplified, but the present disclosure is not limited to such an aspect. For example, the piezoelectric body Zb that is deformed in the Z1 direction by the electrical potential of the individual drive signal Vin[k] that changes from the high electrical potential to the low electrical potential may be used. In this case, for example, the electrical potential of the drive signal COM changes from the low electrical potential to the high electrical potential in a portion corresponding to the expansion element and changes from the high electrical potential to the low electrical potential in a portion corresponding to the contraction element. That is, in the present modification, the electrical potential corresponding to the expansion electrical potential is higher than the electrical potential V0, and the electrical potential corresponding to the contraction electrical potential is lower than the electrical potential V0. Also in the present modification example, the same effects as those of the embodiment and modification examples described above can be obtained.

### Sixth Modification Example

In the embodiment and the modification examples described above, the case where one piezoelectric element PZ, one pressure chamber CV, and one nozzle NZ are provided in each of the ejection sections D is exemplified, but the present disclosure is not limited to such an aspect. For example, each of the ejection sections D may include two piezoelectric elements PZ, two pressure chambers CV, and one nozzle NZ. As described above, also in the present modification example, the same effects as those of the embodiment and modification examples described above can be obtained.

### Seventh Modification Example

The serial-type liquid ejecting apparatus 100 in which the carriage 91 on which the liquid ejecting head 1 is mounted reciprocates in the X-axis direction is described as an example in the embodiment and modification examples described above, but the present disclosure is not limited to such an aspect. For example, the liquid ejecting apparatus 100 may be a line-type liquid ejecting apparatus in which a plurality of nozzles NZ are distributed over the entire width of the medium PP. As described above, also in the present modification example, the same effects as those of the embodiment and modification examples described above can be obtained.

### Eighth Modification Example

The liquid ejecting apparatus 100 described above in the embodiment and modification examples can be used in various types of apparatuses such as a facsimile machine and a copying machine, in addition to an apparatus dedicated to printing. Moreover, the application of the liquid ejecting apparatus according to the present disclosure is not limited to printing. For example, the liquid ejecting apparatus may eject a solution of a coloring material and may be used as a manufacturing device that forms a color filter of a liquid crystal display device. In addition, the liquid ejecting apparatus may eject a solution of a conductive material and may be used as a manufacturing device that forms wiring or an electrode of a wiring substrate. As described above, also in the present modification example, the same effects as those of the embodiment and modification examples described above can be obtained.

### Ninth Modification Example

In the embodiment and the modification examples described above, the evaluation of electrical crosstalk may be executed in a state in which a value of any one of the resistance component, the capacitance component, and the inductance component of the signal wiring or the like from the drive signal generation unit 2 to each ejection section Dis changed. For example, electrical crosstalk may be evaluated by changing conditions such as the length of the FFC and the thickness of a conductor, while the FFC and the conductor are used as a portion of the signal path from the drive signal generation unit 2 to each of the ejection sections D. As described above, also in the present modification example, the same effects as those of the embodiment and modification examples described above can be obtained. In addition, in the present modification, for example, the head manufacturer can propose, to the user, a condition of the FFC or the like suitable for suppressing the occurrence of electrical crosstalk.

### 3. APPENDIXES

From the embodiment described above, for example, the following configurations can be ascertained.

According to a first aspect which is a preferred aspect, a liquid ejecting apparatus includes: a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the plurality of piezoelectric elements is driven; and a controller. The controller causes the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate, causes the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate, and determines a waveform of the drive signal based on the first residual vibration and the second residual vibration.

According to the first aspect, it is possible to appropriately and easily determine the waveform of the drive signal that suppresses the occurrence of electrical crosstalk under a usage condition of the liquid ejecting apparatus.

In the liquid ejecting apparatus according to a second aspect which is a specific example of the first aspect, the controller causes the detecting section to detect, as a third residual vibration, a residual vibration of the vibration plate after the N piezoelectric elements are driven with a third evaluation waveform in which the rate of change in the electrical potential is a third electrical potential change rate lower than the second electrical potential change rate, and determines the waveform of the drive signal based on the first residual vibration, the second residual vibration, and the third residual vibration.

In the second aspect, the same effect as that of the first aspect can be obtained.

In the liquid ejecting apparatus according to a third aspect which is a specific example of the first aspect or the second aspect, the controller causes the detecting section to detect, as a first reference residual vibration, a reference residual vibration of the vibration plate after only M (M is a natural number less than N) piezoelectric elements among the N piezoelectric elements are driven with the first evaluation waveform, and determines the waveform of the drive signal based on the first residual vibration, the second residual vibration, and the first reference residual vibration.

According to the third aspect, the first reference residual vibration after the M piezoelectric elements are driven is also used to determine the waveform of the drive signal. The number of the M piezoelectric elements is less than the number of the N piezoelectric elements. Therefore, in this aspect, it is possible to more appropriately determine the waveform of the drive signal than in the aspects in which the first reference residual vibration is not used.

In the liquid ejecting apparatus according to a fourth aspect which is a specific example of the third aspect, the controller causes the detecting section to detect, as a fourth residual vibration, a residual vibration of the vibration plate after only L (L is a natural number greater than M and less than N) piezoelectric elements among the N piezoelectric elements are driven with the first evaluation waveform, and determines the waveform of the drive signal based on the first residual vibration, the second residual vibration, the fourth residual vibration, and the first reference residual vibration.

According to the fourth aspect, in addition to the first residual vibration after the N piezoelectric elements are driven, the fourth residual vibration after the L piezoelectric elements are driven is used to determine the waveform of the drive signal. Therefore, in this aspect, it is possible to more appropriately determine the waveform of the drive signal than in the aspects in which the fourth residual vibration is not used.

In the liquid ejecting apparatus according to a fifth aspect which is a specific example of any one of the first to fourth aspects, the N nozzles are not adjacent to each other.

According to the fifth aspect, in the detection of the residual vibrations, it is possible to suppress an effect of structural crosstalk which occurred due to the structure of the liquid ejecting head, such as the arrangement of the nozzles, on the residual vibrations. Accordingly, in this aspect, it is possible to accurately detect the residual vibrations.

In the liquid ejecting apparatus according to a sixth aspect which is a specific example of the third aspect or the fourth aspect, the controller sets, as a candidate for the waveform of the drive signal, a waveform in which an electrical potential changes at the first electrical potential change rate when a first amplitude difference obtained by subtracting an amplitude of the first reference residual vibration from an amplitude of the first residual vibration is less than a first threshold which is a positive value, and is greater than a second threshold which is a negative value.

According to the sixth aspect, it is possible to set, as a candidate for the waveform of the drive signal, a waveform in which an electrical potential changes at a rate that causes a small amplitude difference corresponding to the amount of change of an amplitude of a residual vibration when the number of piezoelectric elements driven is changed. As a result, in this aspect, it is possible to appropriately set, as a candidate for the waveform of the drive signal, a waveform in which an electrical potential changes at a rate which suppresses the occurrence of electrical crosstalk. As a result, in this aspect, the rate of change in the electrical potential of the waveform of the drive signal can be appropriately determined to be an electrical potential change rate which suppresses the occurrence of electrical crosstalk.

In the liquid ejecting apparatus according to a seventh aspect which is a specific example of the sixth aspect, when the first amplitude difference is greater than the first threshold or less than the second threshold, the controller does not set, as a candidate for the waveform of the drive signal, the waveform in which the electrical potential changes at the first electrical potential change rate.

In the seventh aspect, the same effects as those in the sixth aspect can be obtained.

In the liquid ejecting apparatus according to an eighth aspect which is a specific example of the first aspect or the second aspect, when an amplitude difference obtained by subtracting a first reference value stored in advance from an amplitude of the first residual vibration is less than a first threshold which is a positive value, and is greater than a second threshold which is a negative value, the controller sets, as a candidate for the waveform of the drive signal, a waveform in which an electrical potential changes at the first electrical potential change rate.

In the eighth aspect, the same effects as those in the first aspect can be obtained.

In the liquid ejecting apparatus according to a ninth aspect which is a specific example of any one of the sixth to eighth aspects, when a plurality of candidates for the waveform of the drive signal are present, the controller sets, as the waveform of the drive signal, a candidate that causes a minimum amplitude difference obtained by subtracting the amplitude of the first reference residual vibration from the amplitude of the first residual vibration among the plurality of candidates.

According to the ninth aspect, it is possible to set, as the rate of change in the electrical potential of the waveform of the drive signal, a rate of change in an electrical potential that causes a small amplitude difference corresponding to the amount of change of an amplitude of a residual vibration when the number of piezoelectric elements driven is changed among a plurality of electrical potential change rates that suppress the occurrence of electrical crosstalk. Therefore, in this aspect, it is possible to suppress a variation in characteristics of ejection of ink depending on the number of piezoelectric elements to be driven.

In the liquid ejecting apparatus according to a tenth aspect which is a specific example of any one of the sixth to eighth aspects, when a plurality of candidates for the waveform of the drive signal are present, the controller sets, as the waveform of the drive signal, a candidate in which an electrical potential changes at a highest rate among the candidates.

According to the tenth aspect, it is possible to set, as the rate of change in the electrical potential of the waveform of the drive signal, the highest rate of change in the electrical potential among the plurality of electrical potential change rates that suppress the occurrence of electrical crosstalk. Therefore, in this aspect, it is possible to efficiently eject a large ink droplet within a desired range.

In the liquid ejecting apparatus according to an eleventh aspect which is a specific example of any one of the sixth to eighth aspects, the controller presents, to a user, candidate information indicating a candidate for the waveform of the drive signal and determines the waveform of the drive signal based on an input by the user for the candidate information.

According to the eleventh aspect, it is possible to allow the user to select the rate of change in the electrical potential of the waveform of the drive signal from among the plurality of electrical potential change rates that suppress the occurrence of electrical crosstalk.

In the liquid ejecting apparatus according to a twelfth aspect which is a specific example of any one of the first to eleventh aspects, the first evaluation waveform includes a first waveform element in which the electrical potential changes at the first electrical potential change rate, the second evaluation waveform includes a second waveform element in which the electrical potential changes at the second electrical potential change rate, a difference between electrical potentials of the first waveform element in a period of time from a start point to an end point of the first waveform element is equal to a difference between electrical potentials of the second waveform element in a period of time from a start point to an end point of the second waveform element, and the period of time from the start point to the end point of the first waveform element is shorter than the period of time from the start point to the end point of the second waveform element.

According to the twelfth aspect, it is possible to adjust the rates of change in the electrical potentials of the waveform elements by adjusting the periods of time from the start points to the end points of the waveform elements.

In the liquid ejecting apparatus according to a thirteenth aspect which is a specific example of any one of the first to eleventh aspects, the first evaluation waveform includes a first waveform element in which the electrical potential changes at the first electrical potential change rate, the second evaluation waveform includes a second waveform element in which the electrical potential changes at the second electrical potential change rate, a difference between electrical potentials of the first waveform element in a period of time from a start point to an end point of the first waveform element is greater than a difference between electrical potentials of the second waveform element in a period of time from a start point to an end point of the second waveform element, and the period of time from the start point to the end point of the first waveform element is equal to the period of time from the start point to the end point of the second waveform element.

According to the thirteenth aspect, it is possible to adjust the rates of change in the electrical potentials of the waveform elements by adjusting the differences between the electrical potentials from the start points to the end points of the waveform elements.

In the liquid ejecting apparatus according to a fourteenth aspect which is a specific example of any one of the first to thirteenth aspects, each of the first evaluation waveform and the second evaluation waveform includes a first expansion element that is a waveform element that expands pressure chambers communicating with the respective nozzles, and a contraction element that is a waveform element after the first expansion element and contracts the pressure chambers, and the first electrical potential change rate and the second electrical potential change rate are rates of change in electrical potentials of the contraction elements.

According to the fourteenth aspect, when a pull-push waveform is used as the waveform of the drive signal, it is possible to accurately determine the rate of change in the electrical potential of the waveform of the drive signal that suppresses the occurrence of electrical crosstalk.

In the liquid ejecting apparatus according to a fifteenth aspect which is a specific example of the fourteenth aspect, each of the first evaluation waveform and the second evaluation waveform further includes a second expansion element that is a waveform element after the contraction element and expands the pressure chambers.

According to the fifteenth aspect, when a pull-push-pull waveform is used as the waveform of the drive signal, it is possible to accurately determine the rate of change in the electrical potential of the waveform of the drive signal that suppresses the occurrence of electrical crosstalk.

In the liquid ejecting apparatus according to a sixteenth aspect which is a specific example of the first aspect or the second aspect, the controller causes the detecting section to detect, as a first reference residual vibration, a reference residual vibration of the vibration plate after only M (M is a natural number less than N) piezoelectric elements among the N piezoelectric elements are driven with the first evaluation waveform, causes the detecting section to detect, as a second reference residual vibration, a reference residual vibration of the vibration plate after only the M piezoelectric elements are driven with the second evaluation waveform, and determines the waveform of the drive signal based on the first residual vibration, the second residual vibration, the first reference residual vibration, and the second reference residual vibration.

In the sixteenth aspect, the same effects as those in the third aspect can be obtained.

In the liquid ejecting apparatus according to a seventeenth aspect which is a specific example of the sixteenth aspect, the controller causes the detecting section to detect, as a fourth residual vibration, a residual vibration of the vibration plate after only L (L is a natural number greater than M and less than N) piezoelectric elements among the N piezoelectric elements are driven with the first evaluation waveform, causes the detecting section to detect, as a fifth residual vibration, a residual vibration of the vibration plate after only the L piezoelectric elements are driven with the second evaluation waveform, and determines the waveform of the drive signal based on the first residual vibration, the second residual vibration, the fourth residual vibration, the fifth residual vibration, the first reference residual vibration, and the second reference residual vibration.

In the seventeenth aspect, the same efforts as those in the fourth aspect can be obtained.

In the liquid ejecting apparatus according to an eighteenth aspect which is a specific example of the sixteenth aspect, when a first amplitude difference obtained by subtracting an amplitude of the first reference residual vibration from an amplitude of the first residual vibration is less than a first threshold which is a positive value, and is greater than a second threshold which is a negative value, the controller sets, as a candidate for the waveform of the drive signal, a waveform in which an electrical potential changes at the first electrical potential change rate, and when a second amplitude difference obtained by subtracting an amplitude of the second reference residual vibration from an amplitude of the second residual vibration is less than the first threshold and greater than the second threshold, the controller sets, as a candidate for the waveform of the drive signal, a waveform in which an electrical potential changes at the second electrical potential change rate.

In the eighteenth aspect, the same effects as those in the sixth aspect can be obtained.

In the liquid ejecting apparatus according to a nineteenth aspect which is a specific example of the eighteenth aspect, when the waveform in which the electrical potential changes at the first electrical potential change rate and the waveform in which the electrical potential changes at the second electrical potential change rate are candidates for the waveform of the drive signal, and an absolute value of the first amplitude difference is less than an absolute value of the second amplitude difference, the controller sets, as the waveform of the drive signal, the waveform in which the electrical potential changes at the first electrical potential change rate, and when the waveform in which the electrical potential changes at the first electrical potential change rate and the waveform in which the electrical potential changes at the second electrical potential change rate are candidates for the waveform of the drive signal, and the absolute value of the second amplitude difference is less than the absolute value of the first amplitude difference, the controller sets, as the waveform of the drive signal, the waveform in which the electrical potential changes at the second electrical potential change rate.

In the nineteenth aspect, the same effects as those in the ninth aspect can be obtained.

In the liquid ejecting apparatus according to a twentieth aspect which is a specific example of the eighteenth aspect, when the waveform in which the electrical potential changes at the first electrical potential change rate and the waveform in which the electrical potential changes at the second electrical potential change rate are candidates for the waveform of the drive signal, the controller sets, as the waveform of the drive signal, the waveform in which the electrical potential changes at the higher rate out of the first electrical potential change rate and the second electrical potential change rate.

In the twentieth aspect, the same effects as those in the tenth aspect can also be obtained.

According to a twenty first aspect which is a preferable aspect, a method of controlling a liquid ejecting apparatus including a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the plurality of piezoelectric elements is driven, and a controller includes causing the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate; causing the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate; and determining a waveform of the drive signal based on the first residual vibration and the second residual vibration.

In the twenty first aspect, the same effect as that in the first aspect can be obtained.

What is claimed is:

1. A liquid ejecting apparatus comprising:
a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the plurality of piezoelectric elements is driven; and
a controller, wherein
the controller
causes the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate,
causes the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate, and
determines a waveform of the drive signal based on the first residual vibration and the second residual vibration.

2. The liquid ejecting apparatus according to claim 1, wherein
the controller
causes the detecting section to detect, as a third residual vibration, a residual vibration of the vibration plate after the N piezoelectric elements are driven with a third evaluation waveform in which the rate of change in the electrical potential is a third electrical potential change rate lower than the second electrical potential change rate, and
determines the waveform of the drive signal based on the first residual vibration, the second residual vibration, and the third residual vibration.

3. The liquid ejecting apparatus according to claim 1, wherein
the controller causes the detecting section to detect, as a first reference residual vibration, a reference residual vibration of the vibration plate after only M piezoelectric elements among the N piezoelectric elements are driven with the first evaluation waveform, M being a natural number less than N, and
the controller determines the waveform of the drive signal based on the first residual vibration, the second residual vibration, and the first reference residual vibration.

4. The liquid ejecting apparatus according to claim 3, wherein
the controller causes the detecting section to detect, as a fourth residual vibration, a residual vibration of the vibration plate after only L piezoelectric elements among the N piezoelectric elements are driven with the first evaluation waveform, L being a natural number greater than M and less than N, and
the controller determines the waveform of the drive signal based on the first residual vibration, the second residual vibration, the fourth residual vibration, and the first reference residual vibration.

5. The liquid ejecting apparatus according to claim 1, wherein
the N nozzles are not adjacent to each other.

6. The liquid ejecting apparatus according to claim 3, wherein
the controller sets, as a candidate for the waveform of the drive signal, a waveform in which an electrical potential changes at the first electrical potential change rate when a first amplitude difference obtained by subtracting an amplitude of the first reference residual vibration from an amplitude of the first residual vibration is less than a first threshold which is a positive value, and is greater than a second threshold which is a negative value.

7. The liquid ejecting apparatus according to claim 6, wherein
when the first amplitude difference is greater than the first threshold or less than the second threshold, the controller does not set, as a candidate for the waveform of the drive signal, the waveform in which the electrical potential changes at the first electrical potential change rate.

8. The liquid ejecting apparatus according to claim 1, wherein
when an amplitude difference obtained by subtracting a first reference value stored in advance from an amplitude of the first residual vibration is less than a first threshold which is a positive value, and is greater than a second threshold which is a negative value, the controller sets, as a candidate for the waveform of the drive signal, a waveform in which an electrical potential changes at the first electrical potential change rate.

9. The liquid ejecting apparatus according to claim 6, wherein
when a plurality of candidates for the waveform of the drive signal are present, the controller sets, as the waveform of the drive signal, a candidate that causes a minimum amplitude difference obtained by subtracting the amplitude of the first reference residual vibration from the amplitude of the first residual vibration among the plurality of candidates.

10. The liquid ejecting apparatus according to claim 6, wherein
when a plurality of candidates for the waveform of the drive signal are present, the controller sets, as the waveform of the drive signal, a candidate in which an electrical potential changes at a highest rate among the candidates.

11. The liquid ejecting apparatus according to claim 6, wherein
the controller presents, to a user, candidate information indicating a candidate for the waveform of the drive signal and determines the waveform of the drive signal based on an input by the user for the candidate information.

12. The liquid ejecting apparatus according to claim 1, wherein
the first evaluation waveform includes a first waveform element in which the electrical potential changes at the first electrical potential change rate,
the second evaluation waveform includes a second waveform element in which the electrical potential changes at the second electrical potential change rate,
a difference between electrical potentials of the first waveform element in a period of time from a start point to an end point of the first waveform element is equal to a difference between electrical potentials of the second waveform element in a period of time from a start point to an end point of the second waveform element, and
the period of time from the start point to the end point of the first waveform element is shorter than the period of time from the start point to the end point of the second waveform element.

13. The liquid ejecting apparatus according to claim 1, wherein
the first evaluation waveform includes a first waveform element in which the electrical potential changes at the first electrical potential change rate,
the second evaluation waveform includes a second waveform element in which the electrical potential changes at the second electrical potential change rate,
a difference between electrical potentials of the first waveform element in a period of time from a start point to an end point of the first waveform element is greater than a difference between electrical potentials of the second waveform element in a period of time from a start point to an end point of the second waveform element, and
the period of time from the start point to the end point of the first waveform element is equal to the period of time from the start point to the end point of the second waveform element.

14. The liquid ejecting apparatus according to claim 1, wherein
each of the first evaluation waveform and the second evaluation waveform includes
a first expansion element that is a waveform element that expands pressure chambers communicating with the respective nozzles, and
a contraction element that is a waveform element after the first expansion element and contracts the pressure chambers, and
the first electrical potential change rate and the second electrical potential change rate are rates of change in electrical potentials of the contraction elements.

15. The liquid ejecting apparatus according to claim 14, wherein
each of the first evaluation waveform and the second evaluation waveform further includes
a second expansion element that is a waveform element after the contraction element and expands the pressure chambers.

16. A method of controlling a liquid ejecting apparatus including a liquid ejecting head including a plurality of nozzles from which liquid is ejected, a plurality of piezoelectric elements that are provided corresponding to the plurality of nozzles and are driven by a drive signal supplied to the plurality of piezoelectric elements, a vibration plate that vibrates by driving of at least one of the plurality of piezoelectric elements, and a detecting section that detects a residual vibration of the vibration plate after the at least one of the plurality of piezoelectric elements is driven, the method comprising:
causing the detecting section to detect, as a first residual vibration, a residual vibration of the vibration plate after N piezoelectric elements corresponding to N nozzles among the plurality of nozzles are driven with a first evaluation waveform in which a rate of change in an electrical potential that is an amount of change in the electrical potential per unit time is a first electrical potential change rate;
causing the detecting section to detect, as a second residual vibration, a residual vibration of the vibration plate after the N piezoelectric elements are driven with a second evaluation waveform in which the rate of change in the electrical potential is a second electrical potential change rate lower than the first electrical potential change rate; and
determining a waveform of the drive signal based on the first residual vibration and the second residual vibration.
